(19) United States
(12) Patent Application Publication
(10) Pub. No.: US 2024/0325819 A1
(43) Pub. Date: Oct. 3, 2024

(54) PORTABLE PHYSICAL PARALLEL BAR SYSTEM

(71) Applicant: WAREOLOGIE, INC., Northville, MI (US)

(72) Inventors: Gina Rae Adams, Northville, MI (US); Jeff Losee, Oxford, MI (US); Tim Lawrence, Oxford, MI (US); Raymond Gardzinski, Macomb, MI (US)

(21) Appl. No.: 18/693,918

(22) PCT Filed: Dec. 15, 2022
(86) PCT No.: PCT/US22/81718

§ 371 Date: Mar. 20, 2024

Related U.S. Application Data
(60) Provisional application No. 63/376,271, filed on Sep. 19, 2022.
(60) Provisional application No. 63/290,612, filed on Dec. 16, 2021.

(51) Int. Cl. A63B 23/04; A63B 22/00

(52) U.S. Cl. CPC A63B 23/0464; A63B 2022/0092; A63B 2022/0094; A63B 2208/0204; A63B 2210/50; A63B 2213/00; A63B 2225/093

(57) ABSTRACT

The present invention is directed to systems and methods for a portable parallel bar system. The system is easily folded as a portable configuration by resting one or more stanchions on a platform of the device. Transport mechanisms may be deployed for easier transport of the device. Cross-members may be employed to provide stability to the device when in the unfolded or in-use configuration.

### CROSS-REFERENCE TO RELATED APPLICATION

This application claims the priority benefits of U.S. Provisional Patent Applications Ser. No. 63/290,612, filed on Dec. 16, 2021; and Ser. No. 63/376,271, filed on Sep. 19, 2022, the contents of each of which are herein incorporated by reference in their entireties.

### TECHNICAL FIELD

This disclosure relates generally to the field of physical therapy, and more specifically to the field of physical therapy for rehabilitating people in walking. Described herein are systems and methods for retracting and folding the physical therapy device for easy portability and compact storage.

### BACKGROUND

Physical therapy and rehabilitation devices are used to assist users in regaining strength, balance, gait, and coordination. Users are transported to offices, clinics or buildings where the physical therapy devices are assembled and remain stationary for a therapy session.

What is needed, therefore, is a more convenient, portable device that does not require the user to travel.

### SUMMARY

In some aspects, the techniques described herein relate to a physical therapy device configured for easy transporting, the physical therapy device including: a first support bracket having a top portion and a bottom portion; a first cross-member coupled to the bottom portion of the first support bracket; and a first stanchion rotatably coupled to the first support bracket at a first hinge point, wherein the device is configured to be transitioned between a folded configuration and an unfolded configuration, wherein, in the unfolded configuration, the first stanchion is configured to rotate about the first hinge point to contact the top portion of the first support bracket above the first hinge point, such that the first stanchion is approximately perpendicular to the first cross-member. wherein, in the folded configuration, the first stanchion is configured to rotate about the first hinge point to be approximately parallel to the first cross-member.

In some aspects, the techniques described herein relate to a physical therapy device configured for easy transporting, the physical therapy device including: a platform including a first lengthwise side and a second lengthwise side, opposite the first lengthwise side; a first set of support brackets positioned on the first lengthwise side of the platform; a second set of support brackets positioned on the second lengthwise side of the platform; a first cross-member perpendicular to the first and second lengthwise sides of the platform; a second cross-member perpendicular to the first and second lengthwise sides of the platform; wherein the first cross-member couples a first support bracket from the first set of support brackets to a second support bracket from the second set of support brackets, wherein the second cross-member couples a third support bracket from the first set of support brackets to a fourth support bracket from the second set of support brackets, a first stanchion rotatably coupled to the first support bracket at a first hinge point; a third stanchion rotatably coupled to the third support bracket at a third hinge position; a second stanchion coupled to the second support bracket; a fourth stanchion coupled to the fourth support bracket; wherein at least the first support bracket and the third support bracket each define a locking pin aperture configured to receive a locking pin.

In some aspects, the techniques described herein relate to a physical therapy device configured for easy transporting, the physical therapy device including: a platform including a first lengthwise side and a second lengthwise side, opposite the first lengthwise side; one or more support brackets coupled to the platform; a first handrail assembly coupled to the first lengthwise side of the platform, wherein the first handrail assembly includes a first handrail coupled to one or more stanchions, a first stanchion is coupled to a portion of the first lengthwise side; wherein the one or more stanchions include an upper portion that is coupled to the first handrail and a bottom portion that is coupled to the one or more respective support brackets; wherein the one or more support brackets define a cutout pin guide; and wherein the bottom portion includes a pin configured to track through the respective cutout pin guide, and, when retracting the first handrail assembly, the one or more stanchions coupled to the first handrail assembly are configured to be raised so that the respective pins track through the respective cutout pin guides to rotate inwardly on a first hinge mechanism.

In some aspects, the techniques described herein relate to a physical therapy device configured for easy transporting, the physical therapy device including: a platform including a first lengthwise side and a second lengthwise side, opposite the first lengthwise side; a plurality of support brackets coupled to the platform; and a first handrail assembly coupled to the first lengthwise side of the platform, wherein the first handrail assembly includes a first handrail coupled to a first stanchion and a second stanchion, the first stanchion is coupled to a first portion of the first lengthwise side and the second stanchion is coupled to a second portion of the first lengthwise side; a second handrail assembly coupled to the second lengthwise side of the platform, wherein the second handrail assembly includes a second handrail coupled to a third stanchion and a fourth stanchion, the third stanchion is coupled to a third portion of the second lengthwise side and the fourth stanchion is coupled to a fourth portion of the second lengthwise side, wherein each stanchion includes an upper portion that is coupled to a respective handrail and a bottom portion that is coupled to a support bracket of the plurality of support brackets, wherein the respective support bracket for the first stanchion defines a locking pin aperture and a cutout pin guide, wherein the bottom portion of the first stanchion includes a pin configured to track through the respective cutout pin guide, and when retracting the first handrail assembly, the first stanchion coupled to the first handrail assembly is configured to be raised so that the respective pin tracks through the respective cutout pin guide to rotate inwardly on a first hinge mechanism.

In some aspects, the techniques described herein relate to a physical therapy device configured for easy transporting, the physical therapy device including: a platform including a first lengthwise side and a second lengthwise side, opposite the first lengthwise side; a first set of two or more support brackets positioned on a first lengthwise side of the platform; a second set of two or more support brackets positioned on a second lengthwise side of the platform; a first cross-member perpendicular to a lengthwise side of the platform; a second cross-member perpendicular to a lengthwise side of the platform; wherein a first support bracket from the first set of support brackets is coupled to a first support bracket from the second set of support brackets by the first cross-member; wherein a second support bracket from the first set of support brackets is coupled to a second support bracket from the second set of support brackets by the second cross-member; a first handrail assembly coupled to the first lengthwise side of the platform by the first set of support brackets, wherein the first handrail assembly includes a first handrail coupled to two stanchions, a first stanchion is coupled to a first portion of the first lengthwise side and a second stanchion is coupled to a second portion of the first lengthwise side; a second handrail assembly coupled to the second lengthwise side of the platform by the second set of support brackets, the second lengthwise side being opposite the first lengthwise side, wherein the second handrail assembly includes a second handrail coupled to two stanchions, a third stanchion is coupled to a third portion of the second lengthwise side and a fourth stanchion is coupled to a fourth portion of the second lengthwise side, wherein each stanchion includes an upper portion that is coupled to a respective handrail and a bottom portion that is coupled to a support bracket of the respective set of support brackets; wherein each support bracket defines a locking pin aperture and a cutout pin guide; and wherein each of the bottom portion of each stanchion includes a pin configured to track through the respective cutout pin guide, and, when retracting the first and second handrail assemblies, the first and second stanchions coupled to the first handrail assembly are configured to be raised so that the respective pins track through the respective cutout pin guides to rotate inwardly on a first hinge mechanism, and the third and fourth stanchions coupled to the second handrail assembly are configured to be raised so that the respective pins track through the respective cutout pin guides to rotate inwardly on a second hinge mechanism, thereby resting on the rotated first handrail assembly.

In some aspects, the techniques described herein relate to a physical therapy device configured for easy transporting, the physical therapy device including: a first support bracket; a first cross-member; and a first handrail assembly coupled to the first support bracket by a first stanchion, wherein the first support bracket defines a cutout pin guide, wherein the cross-member is coupled to the first support bracket, wherein the first cross-member is perpendicular to the first stanchion, when the device is in an unfolded configuration, and the first stanchion is perpendicular to the first handrail, when the device is in either a folded configuration or unfolded configuration, wherein the bottom portion of the first stanchion includes a pin configured to track through the cutout pin guide, and, when retracting the first handrail assembly, the first stanchion coupled to the first handrail assembly is configured to be raised so that the respective pin track through the respective cutout pin guide to rotate inwardly on a first hinge mechanism.

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIG. 1 illustrates a perspective view of one embodiment of a portable physical therapy parallel bar system.

FIG. 2 illustrates a perspective view of the embodiment of FIG. 1 with the handrails at a first height or mid-height.

FIG. 3 illustrates a perspective view of the embodiment of FIG. 1 with the handrails at an extended height.

FIG. 4 illustrates a perspective view of the embodiment of FIG. 1 with the handrails in a first position.

FIG. 5A illustrates an embodiment for adjusting a width of one or more handrails.

FIG. 5B illustrates an embodiment for adjusting a width of one or more handrails.

FIG. 5C illustrates an embodiment for adjusting a width of one or more handrails.

FIG. 5D illustrates an embodiment for adjusting a width of one or more handrails.

FIG. 5E illustrates an embodiment for adjusting a width of one or more handrails.

FIG. 6 illustrates a perspective view of an embodiment of a portable physical therapy parallel bar system in an erected configuration.

FIG. 7A illustrates a perspective view of the handrail extenders of a portable physical therapy parallel bar system at a first position.

FIG. 7B illustrates a perspective view of the handrail extenders of a portable physical therapy parallel bar system at a second position.

FIG. 8 illustrates a perspective view of handrail in a lowered position.

FIG. 9 illustrates a perspective view of the first handrail assembly, which includes the handrail, the upper portions, and the bottom portions being lowered into a retracted, or folded, configuration.

FIG. 10 illustrates a perspective view of the first handrail assembly fully hinged on the platform.

FIG. 11 illustrates a perspective view of the second handrail assembly, which includes handrail, upper portions, and bottom portions, being lowered and hinged in preparation for transporting and/or storing the portable device.

FIG. 12 illustrates a perspective view of the first and second handrail assemblies fully retracted in the transport and/or storing configuration.

FIG. 13 illustrates a perspective view of a portable device in the transport and/or storing configuration.

FIG. 14A shows a zoomed in view of a base of a stanchion to show the locking pin, guide pin, and the cutout guide.

FIG. 14B shows a zoomed in view of a cutout guide of a base of a stanchion, the stanchion being configured to be positioned on top of the second stanchion when in the folded configuration.

FIG. 14C shows a zoomed in view of a cutout guide of a base of a stanchion, the stanchion being configured to be positioned under a second stanchion when in the folded configuration.

FIG. 15A show a bottom side view of a platform, illustrating the structural supports in the platform.

FIG. 15B show a cross-sectional view of a platform portion, illustrating the structural supports in the platform.

FIG. 15C show a perspective view of a platform, illustrating the structural supports in the platform.

FIG. 16 illustrates a perspective view of an embodiment of a portable physical therapy parallel bar system in an erected configuration.

FIG. 17 illustrates a perspective view of the first and second handrail assemblies fully retracted in the transport and/or storing configuration.

FIG. 18 illustrates a perspective view of an adjustable wheel assembly of an embodiment of a portable physical therapy parallel bar system in an erected configuration.

FIG. 19 illustrates a perspective view of an adjustable wheel assembly of an embodiment of a portable physical therapy parallel bar system in a transport and/or storing configuration.

FIG. 20 illustrates a perspective view of the first and second handrail assemblies fully retracted in the transport and/or storing configuration.

FIG. 21 illustrates a perspective view of the first and second handrail assemblies fully retracted in the transport and/or storing configuration.

FIG. 22 illustrates a perspective view of an embodiment of a portable physical therapy parallel bar system in an erected configuration.

FIG. 23 illustrates a perspective view of an embodiment of a portable physical therapy parallel bar system in an erected configuration.

FIG. 24 illustrates a perspective view of an embodiment of a portable physical therapy parallel bar system in the transport and/or storing configuration.

FIG. 25 illustrates a perspective view of support brackets of an embodiment of a portable physical therapy parallel bar system.

FIG. 26 illustrates a perspective view of support brackets of an embodiment of a portable physical therapy parallel bar system.

FIG. 27 illustrates a perspective view of an embodiment of a portable physical therapy parallel bar system in an erected configuration.

FIG. 28 illustrates a perspective view of the first and second handrail assemblies folded in the transport and/or storing configuration of an embodiment of a portable physical therapy parallel bar system.

FIG. 29 illustrates another view of the first and second handrail assemblies folded in the transport and/or storing configuration of an embodiment of a portable physical therapy parallel bar system.

FIG. 30 illustrates another view of an embodiment of a portable physical therapy parallel bar system

FIG. 31 illustrates a zoomed-in view of the wheel assemblies of an embodiment of a portable physical therapy parallel bar system in a folded configuration.

FIG. 32 illustrates a zoomed-in view of the wheel assemblies of an embodiment of a portable physical therapy parallel bar system in an erect configuration with the wheel assemblies retracted.

FIG. 33 illustrates a cross-section of T-track that may be used in conjunction with embodiments of a portable physical therapy parallel bar system.

The illustrated embodiments are merely examples and are not intended to limit the disclosure. The schematics are drawn to illustrate features and concepts and are not necessarily drawn to scale.

### DETAILED DESCRIPTION

The foregoing is a summary, and thus, necessarily limited in detail. The above-mentioned aspects, as well as other aspects, features, and advantages of the present technology will now be described in connection with various embodiments. The inclusion of the following embodiments is not intended to limit the disclosure to these embodiments, but rather to enable any person skilled in the art to make and use the contemplated invention(s). Other embodiments may be utilized, and modifications may be made without departing from the spirit or scope of the subject matter presented herein. Aspects of the disclosure, as described and illustrated herein, can be arranged, combined, modified, and designed in a variety of different formulations, all of which are explicitly contemplated and form part of this disclosure.

Conventional physical therapy devices are large, immovable, and heavy. For a patient to use the device, the patient needs to be transported to the physical therapy device. This may be difficult for some patients that have more severe health conditions, for example requiring lots of connections and tubing to health monitoring devices. Further, some patients are remote from the hospital and have limited access to physical therapy devices, and transporting these patients, on a regular basis, to a location having a physical therapy device is cumbersome and unlikely to occur. Further, although the systems, devices, and methods described herein are described with respect to physical therapy, one of skill in the art will appreciate that the systems, methods, and devices described herein may also be used for general wellness, exercise, gymnastics, and the like.

The devices described herein solve the above technical problems. The technical solutions provided by the devices described herein include foldable and transportable physical therapy devices that are lighter weight while maintaining the “feeling” of a non-portable physical therapy device. When a patient uses a physical therapy device, she wants to feel that the device is stable, will support her weight (especially when leveraging the device to go from sitting to standing), and does not wiggle or creak while in use. The devices described herein solve these technical problems by providing foldable parallel bar devices that are easily transportable to and from individuals and also allow for compact storage while in the folded configuration. The portable device also functions to quickly and easily unfold and become immovably secure to provide a stable, rigid device for a user to walk and lean on without fear of the device collapsing. Further, the portable device functions to provide a parallel bar system that is adjustable according to the size of a user. The device is used when users may require or desire the assistance of parallel bars, or handrails, to walk, gain strength, and/or improve coordination and balance, but can additionally or alternatively be used for any suitable application, such as other rehabilitative mobility exercises, training physical therapists, or general exercising.

Notably, the portable parallel bar devices are foldable into a portable component. More specifically, it will be appreciated that the portable devices require appreciably few if any, components of the devices to be disassembled or removed prior to folding into the portable, or retracted, configuration. Advantageously, components of the portable devices remain coupled in some manner to avoid losing or keeping track of disassembled or removed components. The portable devices may also include a transport mechanism, for example, wheels, casters, etc. that allow for easy transport or movement while in the folded configuration. Additionally, and optionally, storage compartments may be integrated into the portable devices to allow for storage of items, such as manuals, instructions, bands, therapy devices, or any other personal items.

While the portable devices are easily transportable, the construction design and materials allow a user to erect the portable device easily and quickly for immediate use. An erected or unfolded configuration is herein synonymous with a use configuration. The portable devices described herein are stable and rigid enough to allow users of a wide range of sizes and weights to walk across, lean against, and/or pull themselves along or upright. Additionally, it is anticipated that a therapist may also have to walk across the device along with the user and/or a user may use a wheelchair on the device, thereby adding additional weight requirements. Therefore, specifications for the portable device require the selected materials to be adequately strong and durable, while remaining lightweight for portability and cost effectiveness. The materials used in constructing the portable device may include one or more of: metals, such as a lightweight steel, aluminum, or titanium, and/or non-metallic materials, such as rigid plastics, composite materials, carbon fiber or other fiber-reinforced plastics, flexible materials such as foam mats, inflatable air mats.

Further, the portable device is designed for easy adjustability according to a wide range of user sizes. As will be discussed further below, handrails, for example, may be raised or lowered depending upon the height of the user. Additionally, handrails may be adjusted inwardly or outwardly depending on, for example, an arm reach or girth of the user. In this manner, the portable device may be used for users of a wide range of individual sizes. Further, length extenders may be integrated into the handrails that are configured to extend the overall handrail length allowing for a user in a wheelchair, for example, to approach the portable device in a seated position, hold onto the extenders, and pull themselves upright before walking across a platform of the portable device.

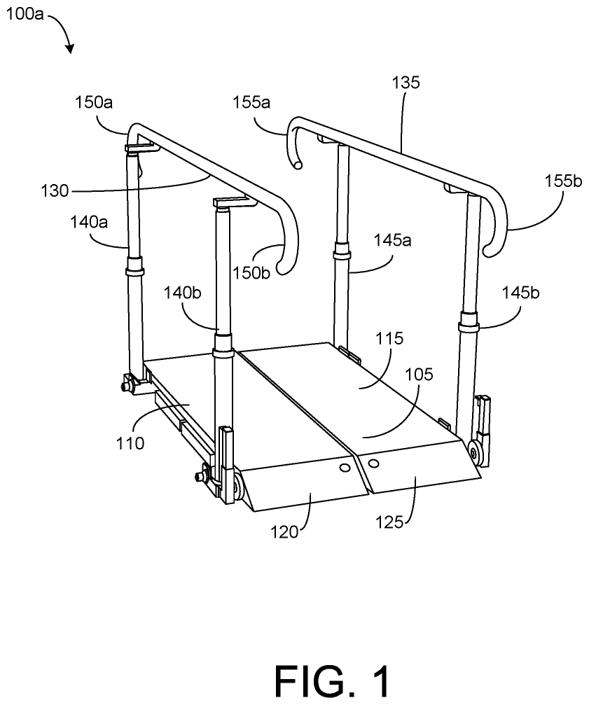

FIG. 1 illustrates one embodiment of the portable parallel bar device. As shown, the portable device 100a is fully erected and ready for use. A platform 105 is in a downward or use position configured to allow one or more users to stand on and/or walk across. The platform 105 comprises one or more base panels 110, 115. Although two base panels are shown, one base panel may be used or a plurality of base panels may be used Optionally, each base panel 110, 115 may have an angled ramp 120, 125 on one or both ends that allows easy access onto and off of the platform 105. Further, as described elsewhere herein, an angled ramp may be removable such that two or more devices, with complementary connection features, may be coupled together to create an elongated physical therapy device. A further embodiment of the base panel may be a mat having a material and thickness to support a user. The material may be a foam, air, or fibrous material, for example. The base panel may be constructed to fold in a series of alternating folds, for example, similar to an accordion, along several lengths and/or widths. The base panel may comprise a plurality of extruded panels bonded together to form the base panel. The base panel may remain integrated in the retracted portable device or also may be removed completely. It will be appreciated that the portable device may also be constructed to utilize the floor, thus not requiring the base panel 110, 115.

Handrails 130, 135 run parallel along a lengthwise side of the platform 105 and are coupled to stanchions 140a, 140b, 145a, 145b located on each lengthwise edge of the platform 105. In one embodiment, the length of the platform 105 and handrails 130, 135 may be about 1.2 m (4 ft); about 0.6 m (2 ft) to about 1.8 m (6 ft); about 1 m (3.5 ft) to about 1.4 m (4.5 ft); etc. It will be appreciated, however, that the platform 105 may be configured into any length, such as about 0.9 m (3 ft) to about 1.5 m (5 ft). Handles 150a, 150b, 155a, 155b (e.g., may or may not be curved) may be configured on one or both ends of the handrails 130, 135 that allow for easy grabbing and assisting users as they step onto the platform 105. The handles 150a, 150b, 155a, 155b on one or both ends of the handrails 130, 135 may also adjustably extend outward from the handrails 130, 135. For example, the handles 150a, 150b, 155a, 155b may be removably or irreversibly coupled to the device, such that the handles 150a, 150b, 155a, 155b may be a component (e.g., cylindrical, square, rectangular, etc.) that is inserted into a hollowed handrail. Integrated into the handles 150a, 150b, 155a, 155b and the handrails 130, 135 may be holes and locking pins for setting a desired extension length. For example, each handrail may define an aperture for receiving a spring-loaded pin of a corresponding handle. Further for example, each handle may define an aperture for receiving a spring-loaded pin of a corresponding handrail. Alternatively, the handrail and corresponding handle may each define an aperture that, when aligned with each other, are configured to receive a pin therethrough. The handrail and handle may also be friction fit, threaded to one another, or the like. In some variations, the handles 150a, 150b, 155a, 155b may telescope outward and retract inward. Alternatively, or additionally, the handles may be of a suitable length and have a suitable tension that they can be extended without a physical locking mechanism. It will be appreciated that the extended distance may be selected based on the user's desire and needs. For example, a user in a wheelchair may approach the platform 105, grab onto the extended handles 150a, 150b, 155a, 155b and pull themselves upright from their seated position without the wheelchair having to get onto the platform 105 and without requiring the user to lean too far forward to reach unextended handles 150a, 150b, 155a, 155b. In some examples, the handle may be extended to about 0.3 m (1 ft); about 0.15 m (0.5 ft) to about 0.5 m (1.5 ft); about 0.1 m (0.25 ft) to about 0.4 m (1.25 ft); about 0.3 m (1 ft) to about 0.9 m (3 ft); etc. depending on the user's physical range of motion or comfort level.

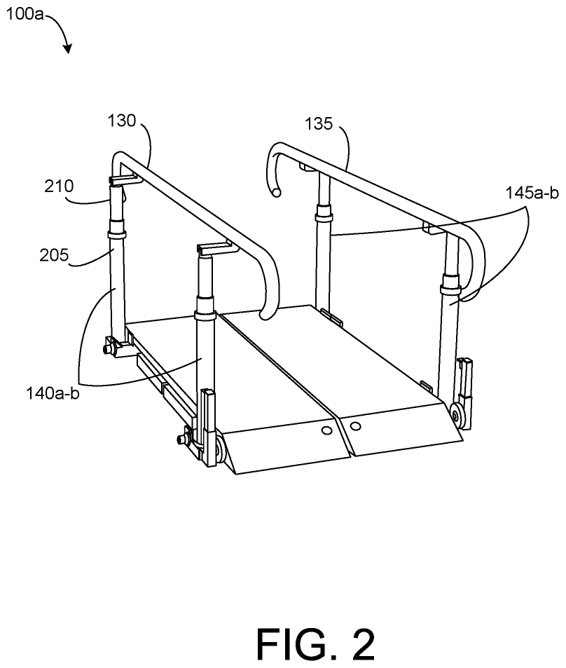

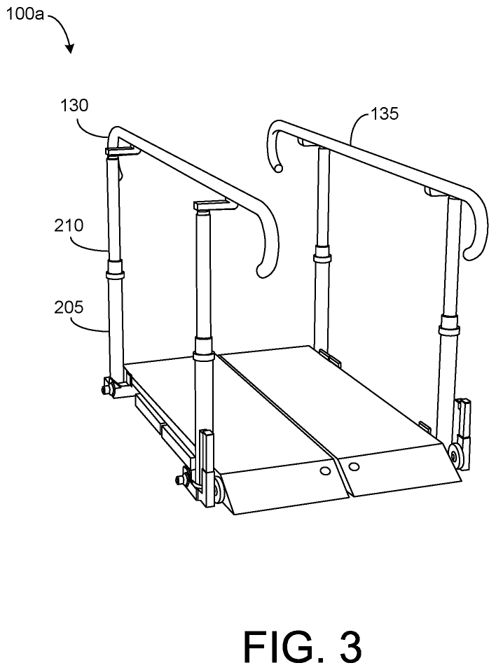

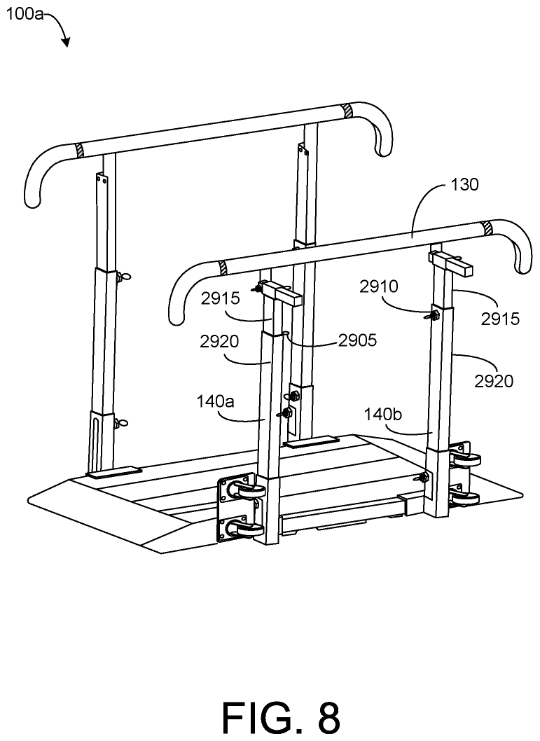

FIGS. 2 and 3 illustrate one embodiment of height-adjustable handrails of the portable parallel bar device. The handrails 130, 135 are configured to adjust to a height that is suitable for the user to hold while walking across the platform 105, for example, from about 71 cm (28 in) to about 102 cm (40 in); about 64 cm (25 in) to about 127 cm (50 in); about 38 cm (15 in) to about 114 cm (45 in); about 51 cm (20 in) to about 102 cm (40 in); etc. in height. Various methods and/or mechanisms are envisioned for adjusting and locking the handrails to the desired height. In one embodiment, each of the stanchions 140a, 140b, 145a, 145b may be telescoping. For example, each stanchion may be configured with an outer member 205 and an inner member 210. As shown in FIGS. 2-3, the outer member 205 may be stationary and the inner member 210 may be height adjustable, relative to the outer member 205. Each of the outer member 205 and inner member 210 may include a number of holes that, when aligned, correspond to a desired height. Markings or numbers may also be present on the outer member 205 and/or inner member 210 to identify the various heights for easy reference. In this manner, the height-adjustable handrails 130, 135 may simply be pulled up or pushed down to a desired height position. A lock and release mechanism, such as, for example, a pin (e.g., shown in FIG. 8), may be integrated with or attached to the outer member 205 of each of the stanchions 140a, 140b, 145a, 145b. For example, the pin may be attached to the stanchions with a cord or plastic tab and inserted into one of the number of holes corresponding to the desired height position, thereby locking the handrails 130, 135 in place.

Another embodiment may include pneumatic members, air members, or hydraulic members integrated into the stanchions 140a, 140b, 145a, 145b that are configured to extend, lock, and retract corresponding handrails 130, 135 to the desired height. Other embodiments may include electrically powered motorized lifts incorporated into the stanchions 140a, 140b, 145a, 145b. One of skill in the art will appreciate that one or more of the stanchions may employ one mechanism for height adjustment while another of the one or more stanchions may employ a different mechanism for height adjustment. FIG. 2 illustrates the adjustable handrails 130, 135 in a first lower position, and FIG. 3 illustrates the adjustable handrails 130, 135 in a second higher position with the inner member 210 of the stanchions 140a, 140b, 145a, 145b further extended relative to the outer member 205. It will be appreciated that each handrail 130, 135 may be independently adjusted and may be positioned to varying heights. For example, one handrail 130 may be positioned higher than the opposite handrail 135. Additionally, an end of one handrail 130 may be positioned higher than the other end of the same handrail 130, such that handrail 130 may be sloped or slanted.

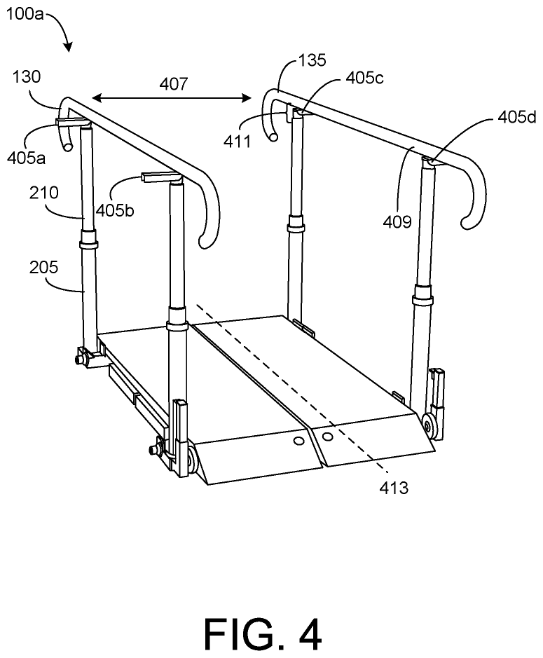

FIG. 4 illustrates one embodiment of width-adjustable handrails 130, 135 of the portable parallel bar device 100a. As shown, the handrails 130, 135 are configured to adjust to a width 407 between the handrails that is suitable for the user. For example, the handrails 130, 135 may adjust from about 71 cm (28 in) to about 92 cm (36 in); about 64 cm (25 in) to about 102 cm (40 in); about 51 cm (20 in) to about 127 (50 in); etc. in width 407. Width extenders 405a, 405b, 405c, 405d are adjustably coupled to each of a top portion 411 of the inner member 210 and coupled to a portion (e.g., a bottom surface 409) of the handrails 130, 135. In this manner, various width adjustments may be made by sliding the width extenders 405a, 405b, 405c, 405d in one direction or another relative to the inner member 210. In one embodiment, the width extenders 405a, 405b, 405c, 405d are about 4 inches in length, however, it is envisioned that the extenders may be shorter or longer depending on the design. Further, although both handrails are shown with width extenders, it will be appreciated that none of the handrails may be width adjustable. Further, one handrail may have width extenders associated with each stanchion. Still further, one handrail may have a width extender associated with one stanchion, such that the handrail is configured to angle inward or outward with respect to a longitudinal axis 413 of the device 100a.

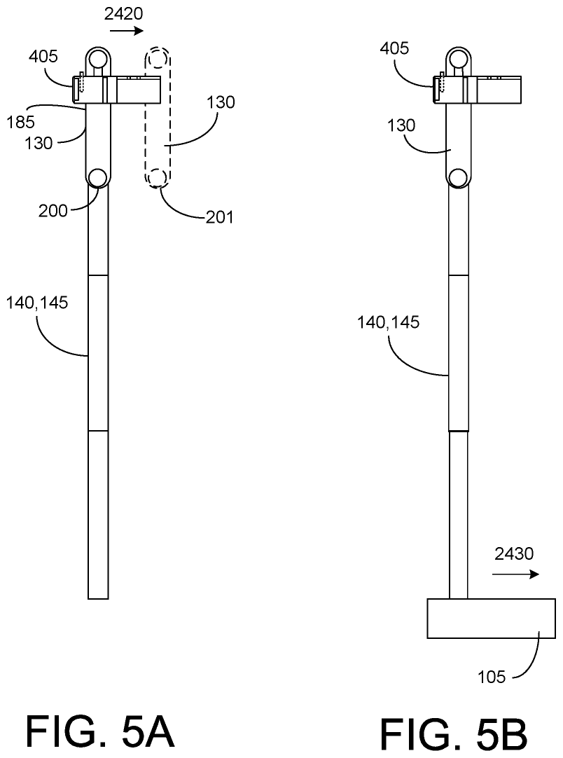

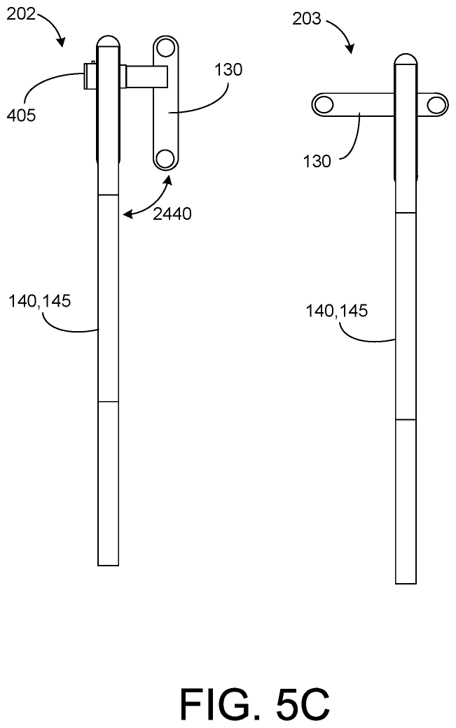

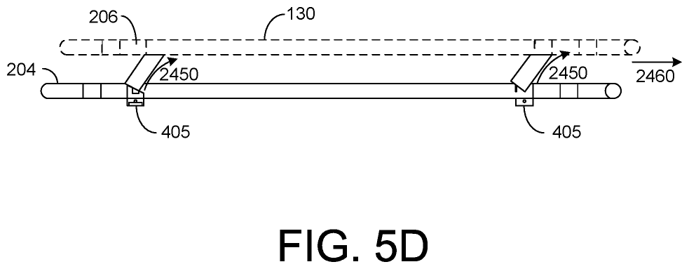

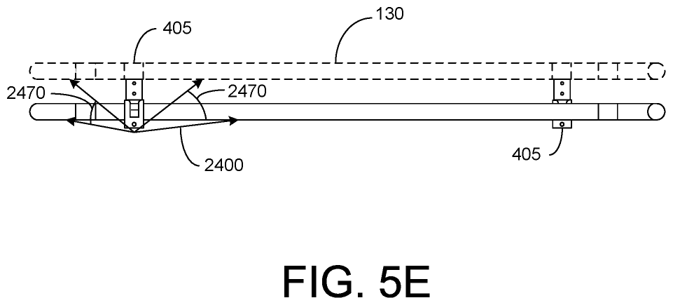

FIGS. 5A-5E show various embodiments for adjusting a handrail width 195 of the first handrail 130 or the second handrail 135, relative to a respective stanchion, or adjusting a width 175 between the first handrail 130 and the second handrail 135. FIGS. 5A-5E show a prior position 200 of handrail 130 and an adjusted position 201 of handrail 130 for illustrative purposes. For example, as shown in FIG. 5A and described elsewhere herein, the first handrail 130 and/or the second handrail 135 may slide substantially horizontally, shown by arrow 2420, at the top portion 185 a first stanchion 140 and a second stanchion 145 along the corresponding width extenders 405. In another embodiment, as shown in FIG. 5B, the first stanchion 140 and/or the second stanchion 145 may slide in and out substantially horizontally, shown by arrow 2430, with respect to the platform 105 to adjust a width 407 (shown in FIG. 4) between the first handrail 130 and the second handrail 135. In a further embodiment, as shown in FIG. 5C, the first handrail 130 and/or the second handrail 135 tilts in or out along a path shown by arrow 2440, between a first position 202 and a second adjusted position 203, to adjust a width between the handrails. In such embodiments, the first stanchion 140, the second stanchion 145, and/or one or more width extenders may include a mechanism such as a hinge or another analogous device known in the art to accommodate the tilting. In a still further embodiment, as shown in FIG. 5D, each width extender 405 may rotate along a path shown by arrows 2450 to pivot the first handrail 130 and/or the second handrail 135 substantially horizontally (shown by arrow 2460) relative to the stanchions between a first position 204 and a second position 206. As such, the first handrail 130 and/or the second handrail are configured to travel horizontally 2460 during adjustment. In another embodiment, as shown in FIG. 5E, one or more scissoring mechanisms 2400 are used in place of the width extenders 405, such that angle 2470 increases or decreases, respectively, to decrease or increase the width between the first handrail 130 and the second handrail 135. The scissoring mechanism 2400 may be applied to the first handrail 130 and/or the second handrail 135.

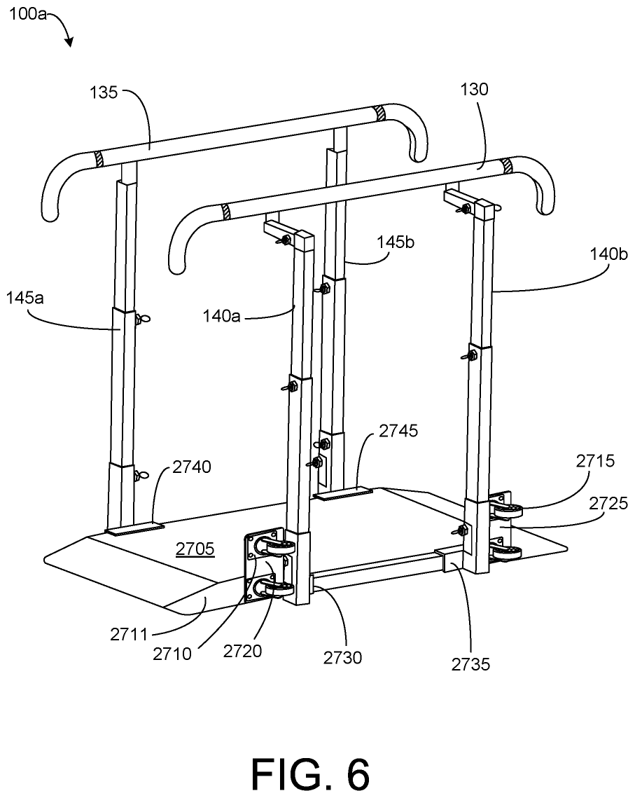

FIG. 6 illustrates a perspective view of an embodiment of the portable physical therapy parallel bar system 100a in an erected or unfolded configuration. As shown in this embodiment, one or more wheels, or castors, 2710, 2715, are positioned on one or more sides of the platform 2705. One or more wheels 2710, 2715 are mounted to each plate 2720, 2725, which may be fabricated from metal or some other comparable, durable material. The plates 2720, 2725 may be separate pieces that are bolted, welded, or otherwise coupled, to a surface of platform 2705 or platform brackets 2730, 2735. Alternatively, the platform brackets 2730, 2735 and the plates 2720, 2725 may be fabricated as a single piece. One or more wheels 2710, 2715 are mounted, such as with bolts or welding, to an outside surface (facing outward from the platform 2705) of each plate 2720, 2725 respectively. It will be appreciated that any number of wheels, or castors, may be used, such as, for example, one large wheel or four smaller wheels or one wheel per plate, two wheels per plate, etc. Further, the plates 2720, 2725 may be larger in width and/or height to accommodate any configuration of wheels and ensure stability of the device 100a when in a transport and/or storing configuration. In one embodiment, platform brackets 2730, 2735, 2740, 2745 are configured as a u-bracket to wraparound an outer edge 2711 of the platform 2705 and secure at least a portion (e.g., a bottom portion) of the stanchion 140a, 140b, 145a, 145b to the platform 2705. The platform 2705 is secured in the u-brackets 2730, 2735, 2740, 2745 with bolts or screws. They are manufactured of stainless steel, reinforced fibers, or other comparable durable material.

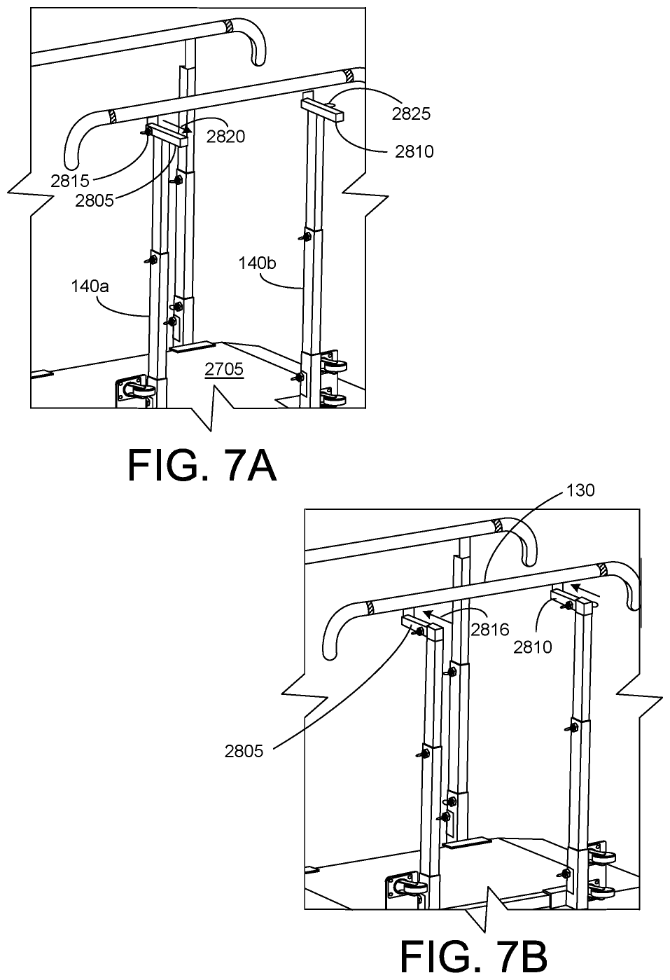

FIGS. 7A-7B illustrate a perspective view of the handrail extenders of a portable physical therapy parallel bar device. As shown, width extenders 2805, 2810 are coupled to one or both of the handrails. For example, in the embodiment of FIGS. 7A-7B, one handrail 130 includes a width extender 2805, 2810 that is aligned with the stanchions 140a, 140b to mate with an upper portion of the stanchions 140a, 140b. The width extenders 2805, 2810 are configured to allow handrail 130 to horizontally move inwardly, shown by arrow 2816, and outwardly, shown by arrow 2820, relative to the platform 105 (e.g., a longitudinal axis 413 of the platform 105 as shown in FIG. 4) to adjust the overall width 407 (shown in FIG. 4) between the handrails 130, 135. In one embodiment, one or more locking, or retaining, pins 2815, 2825 are positioned in aligned holes, or apertures, in the extenders 2805, 2810 and the upper portion of the stanchions 140a, 140b to secure the handrail 130 at a first, unextended, position. The locking pins 2815, 2825 may be released, or unlocked, from the holes, thereby allowing the handrail 130 to horizontally move, or slide, inwardly, such as shown by arrow 2816 of FIG. 7B, to a desired, or second or extended, position. There may be one or a number of holes in the extenders 2805, 2810 in order to select varying width positions. Once in the desired position, the locking pins 2815, 2825 may be secured, or locked, into the aligned holes, thereby stabilizing and securing the handrail 130 to the stanchions 140a, 140b. It will be appreciated that only one pin may be required to secure the handrail 130. Further, though only one handrail 130 is shown having the configurable width extenders 2805, 2810, the opposite handrail 135 may also be configured with extenders to further adjust the width 407 (shown in FIG. 4) between the handrails 130, 135. It will be appreciated that other extenders 2805, 2810 are envisioned that do not require locking pins, such as friction-based extenders, small-motor extenders, etc. Furthermore, the hole diameter and pin diameter may have a relatively tight tolerance to minimize movement when locked. Additionally, it will be appreciated that the defined holes may be concave and receive a locking pin with a convex portion to reduce movement further.

FIG. 8 illustrates a perspective view of handrail 130 in a lowered position. As shown, handrail 130 is lowered by releasing, or unlocking, locking pins 2905 and 2910 and pressing the handrail 130 down. An upper portion 2915 of each of the stanchions 140a, 140b slides downward into a bottom portion 2920. At the lowered level, the locking pins 2905, 2910 may be locked into aligned holes securing the handrail 130 in the lowered position. Although one lowered position is shown, there may be any number of heights to which the stanchions can be adjusted.

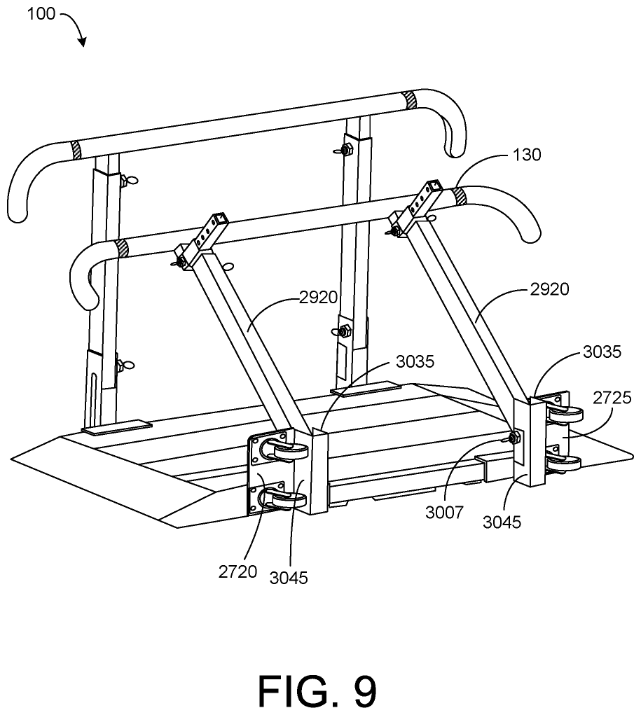

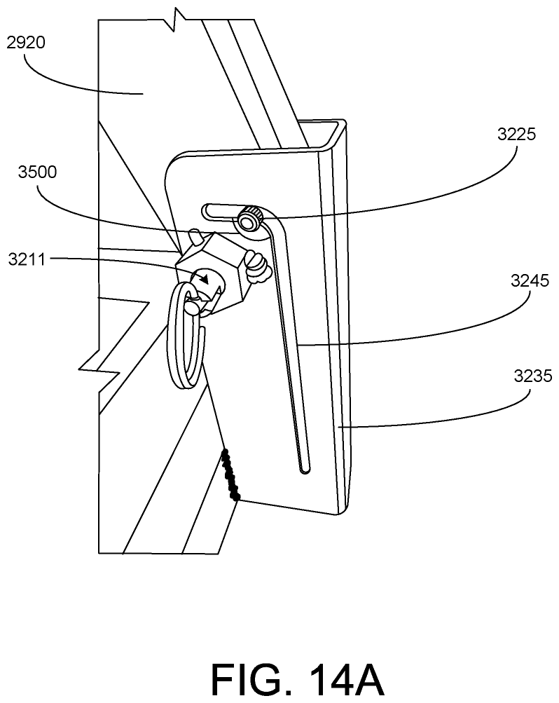

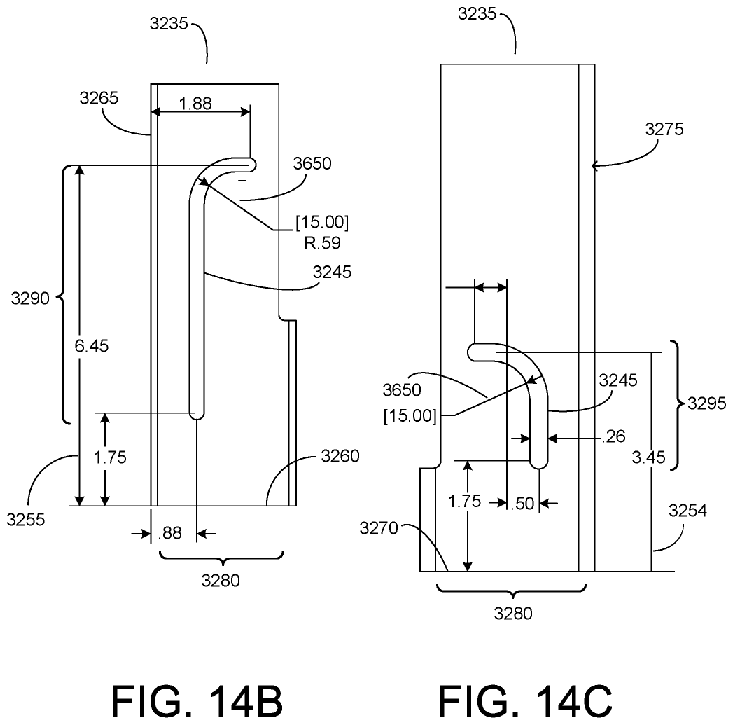

FIG. 9 illustrates a perspective view of the first handrail assembly, which includes the handrail 130, the upper portions 2915 (shown in FIG. 8), and the stanchion bottom portions 2920, being lowered into a retracted, or folded, configuration. As shown, the handrail assembly is configured to hinge, or rotate, inwardly in preparation for transporting and/or storing the portable device 100. As configured in one embodiment, the plates 2720, 2725 include support brackets 3035 to support and prevent the handrail assembly or stanchions from over-rotating outwardly (relative to a longitudinal axis 413 shown in FIG. 4) past a substantially perpendicular angle relative to the platform 2705. In this manner, the support brackets 3035 are configured with apertures that align with apertures in the bottom portions 2920 and utilize the locking pins 3007 to release the handrail assembly from the brackets 3035 as well as secure the handrail assembly when in an erected or unfolded configuration. It will be appreciated that, while the brackets 3035 are shown as a u-shape having substantially 45 degree angles, the brackets 3035 may be of any configuration that is sized and/or shaped to receive the bottom portions 2920 of the stanchions, such as a circular or rounded shape. Locking pins 3007 (only one locking pin is shown in FIG. 9) are released allowing the handrail assembly to hinge inwardly (relative to a longitudinal axis 413, shown in FIG. 4). In some instances, handrail assembly may be partially lifted prior to hinging inwardly. For example, in some embodiments, a bottom portion 2920 of the stanchion includes a guide pin (e.g., shown as 3225 in FIG. 14A) that is configured to be inserted into a cutout pin guide 3045.

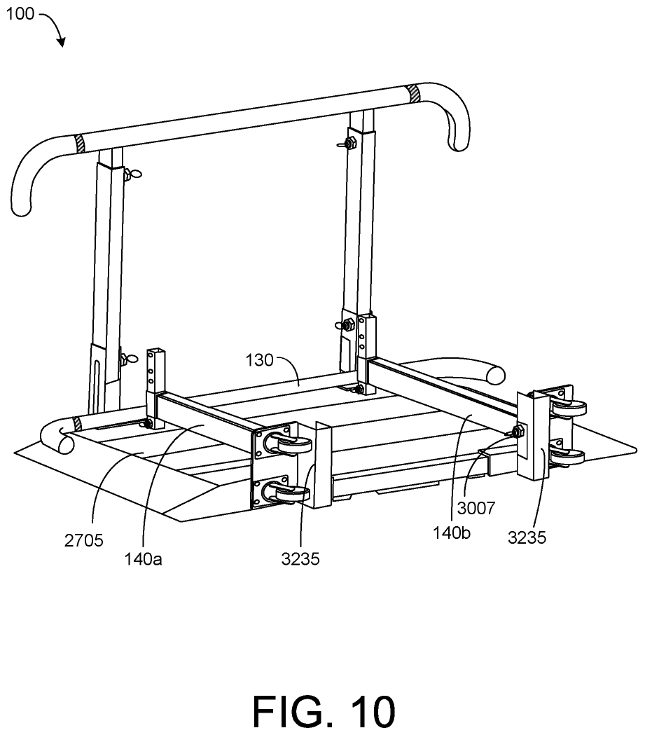

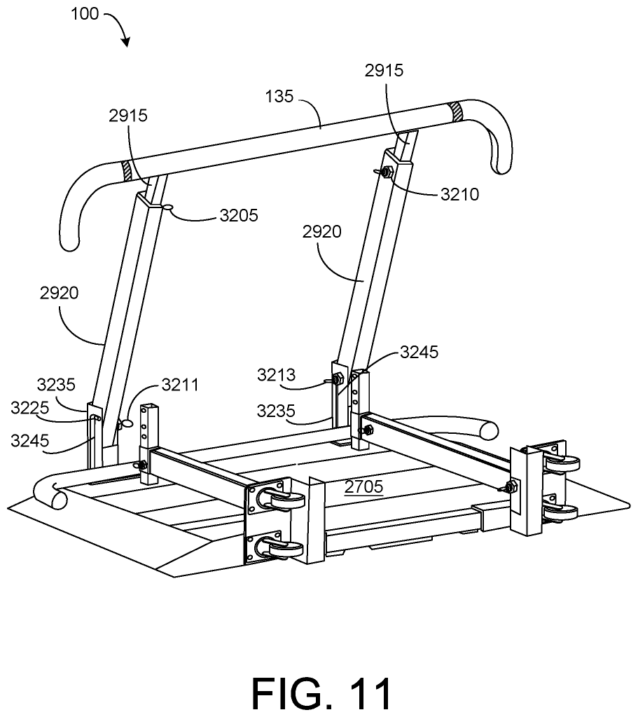

As shown in FIG. 14A, the cutout pin guide 3245 in the support bracket 3235 has an arcuate, or curved, upper portion where a guide pin 3225 on the bottom portion of the stanchion is guided up and along the arcuate curve prior to allowing the handrail assembly to rotate, or hinge, inward. The guide pin 3225 and cutout pin guide 3245 stabilize the assembly during use (in unfolded configuration) and easily allowing the handrail assembly to hinge inward toward platform 2705 (e.g., as shown in FIG. 11). An angle 3500 of the cutout pin guide 3245 may be about 70 degrees to about 150 degrees, about 80 degrees to about 130 degrees, about 90 degrees to about 130 degrees, about 100 degrees to about 120 degrees, etc. For example, in one embodiment, the angle 3500 is about 90 degrees; in another embodiment, the angle 3500 is about 120 degrees. As the guide pin of handrail assembly is routed through the arcuate guide 3245, the handrail assembly hinges on a hinge mechanism (not shown) to contact the bottom portions 2920 of the stanchions 140a, 140b to the support brackets 3235. FIG. 10 illustrates a perspective view of the first handrail assembly including handrail 130 and stanchions 140a, 140b fully hinged on the platform 2705. The support brackets 3235 and the cutout pin guide 3245 (shown in FIG. 14A) further prevent the stanchions 140a, 140b from falling over even when unlocked (e.g., locking pin 3007 is removed). The stanchion 140a, 140b rests in brackets 3235 and cannot move unless pulled up and out.

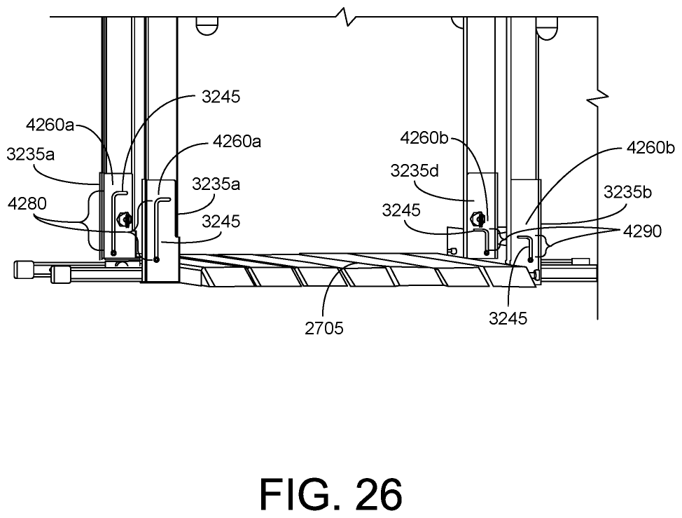

FIG. 14B shows an embodiment of the support bracket 3235 with dimensions. This embodied support bracket 3235 may be representative of support brackets 3235a and 3235b in FIG. 26. As depicted in FIG. 14B, the cutout pin guide 3245 may start at a distance from the bottom surface 3260 of about 30 mm to about 60 mm; about 35 mm to about 55 mm; about 40 mm to about 50 mm; about 42 mm to about 48 mm, etc. The cutout pin guide 3245 may extend from the bottom surface 3260 to a distance of about 150 mm to about 180 mm; about 155 mm to about 175 mm; about 160 mm to about 170 mm; about 162 mm to about 166 mm, etc. The cutout guide pin 3245 may have a closest distance to the back surface 3265 of about 10 mm to about 30 mm; about 15 mm to about 25 mm; about 20 mm to about 24 mm, etc. The cutout guide pin 3245 may have a farthest distance to the back surface 3265 of about 30 mm to about 60 mm; about 35 mm to about 55 mm; about 40 mm to about 50 mm; about 45 mm to about 49 mm, etc. The cutout pin guide 3245 may be dimensioned such that when the stanchions are in the erect position, the lowest portion of the stanchion rest on a portion of the support bracket 3235, or on the surface the device is resting on. These embodiments would allow the described contact before the guide pin reaches the bottom of the cutout pin guide 3245. The described configuration alleviates stress on the guide pin when the device is in use.

FIG. 14C shows an embodiment of the support bracket 3235 with dimensions. This embodied support bracket 3235 may be representative of support brackets 3235c and 3235d of FIG. 26. As depicted in FIG. 14C, the cutout pin guide 3245 may start at a distance from the bottom surface 3270 of about 30 mm to about 60 mm; about 35 mm to about 55 mm; about 40 mm to about 50 mm; about 42 mm to about 48 mm, etc. The cutout pin guide 3245 may then extend from the bottom surface 3270 to a distance of about 70 mm to about 100 mm; about 75 mm to about 95 mm; about 80 mm to about 90 mm; about 85 mm to about 90 mm, etc. The cutout guide pin 3245 may have a closest distance to the back surface 3275 of about 10 mm to about 30 mm; about 15 mm to about 25 mm; about 20 mm to about 24 mm, etc. The cutout guide pin 3245 may have a farthest distance to the back surface 3275 of about 30 mm to about 60 mm; about 35 mm to about 55 mm; about 40 mm to about 50 mm; about 45 mm to about 49 mm, etc. The cutout pin guide 3245 of the embodied support brackets 3235a, 3235b, 3235c, 3235d may have a slot diameter of about 2 mm to about 10 mm; about 4 mm to about 8 mm; about 5 mm to about 7 mm, etc. Further, in embodiments in which the support brackets 3235a and 3235b (e.g., shown in FIG. 26) are of the embodied types of FIG. 14B and the support brackets 3235c and 3235d (of FIG. 26) are of the embodied types of FIG. 14C, the slot length 3290 of the embodied support bracket of FIG. 14B may be longer than slot length 3295 of support bracket of FIG. 14C by a percentage of about 200% to about 270%; about 210% to about 260%; about 220% to about 250%; about 230% to about 240%, etc. Further, in the embodied support brackets, the inner diameter 3280 of the support bracket may be longer than the radius 3650 of the arcuate bend by a percentage of about 220% to about 320%; about 230% to about 310%; about 240% to about 300%; about 250% to about 290%, etc.

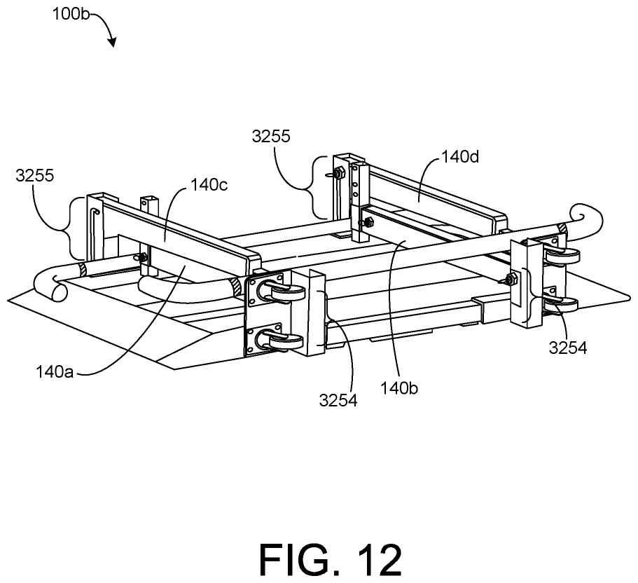

FIG. 11 illustrates a perspective view of the second handrail assembly, which includes handrail 135, stanchion upper portions 2915, and stanchion bottom portions 2920, being lowered and hinged in preparation for transporting and/or storing the portable device 100. In a similar manner as positioning the first handrail assembly into the retracted, or folded, position, locking pins 3205, 3210 are released, or unlocked, from aligned holes located in the upper portions 2915 and the lower portions 2920 of stanchions thereby allowing the upper portion 2915 and the handrail 135 to lower into the bottom portion 2920. Support brackets 3235 support and prevent the second handrail assembly from over-rotating outwardly (relative to a longitudinal axis 413, shown in FIG. 4) past a perpendicular angle relative to the platform 2705. At the lowered position, locking pins 3211, 3213 are released, or unlocked, from the support brackets to allow the second handrail assembly to hinge along a second cutout pin guide 3245. In some instances, a handrail assembly may be lifted to hinge along a cutout pin guide. Each bottom portion 2920 includes a respective guide pin 3225 that is configured to be inserted into a respective cutout pin guide 3245. As shown, the cutout pin guide 3245 has an arcuate, or curved, upper portion where the guide pin 3225 on the bottom portion 2920 is guided up and along the arcuate curve to allow the second handrail assembly to rotate, or hinge, inward. The guide pin 3225 and cutout pin guide 3245 stabilize the assembly while easily allowing the stanchions or handrail assembly to hinge inwardly. Once the stanchion is tracked through the arcuate guide 3245, the stanchion hinges on a hinge mechanism (not shown) to vertically erect the bottom portions 2920 of the stanchions in support brackets 3235, thereby erecting the stanchion and thus the handrail assembly. FIG. 12 illustrates a perspective view of a portable physical therapy device 100b in a folded configuration where the first and second handrail assemblies retracted in the transport and/or storing configuration.

In some instances, in the folded configuration of any of the embodiments described herein, the top stanchions 140c, 140d may be coupled or secured to the bottom stanchions 140a, 140b. The coupling mechanism may include magnets, straps, complementary friction fit features, locking pins, or the like. For example, stanchions 140c, 140d may include a permanent magnet or a ferromagnet and stanchions 140a, 140b may also include a permanent magnet or a ferromagnet.

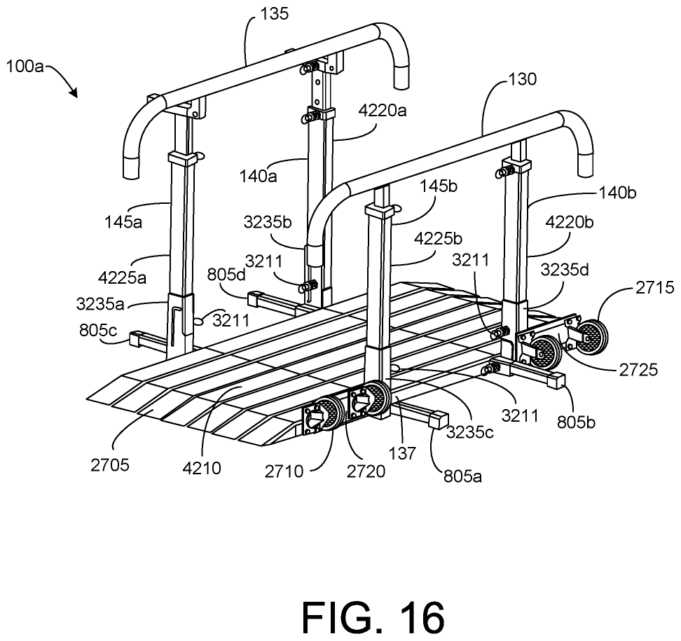

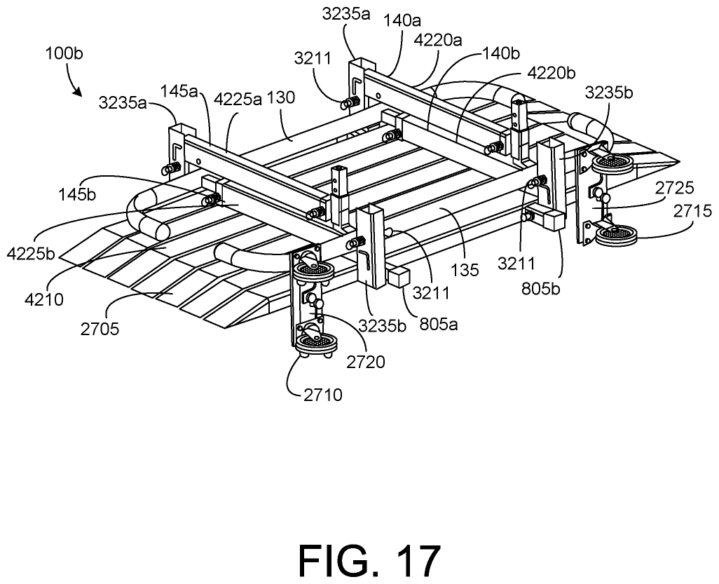

As described above, each stanchion, as shown in FIG. 11, further includes a locking pin 3211, 3213 that mates with a locking aperture defined by each support bracket 3235. Another example of locking pins 3211 and the positioning of them may be seen in FIGS. 16 and 17. The locking pins 3211, 3213 function to lock each stanchion within the respective support bracket 3235. However, if one or both locking pins 3211, 3213 are removed from a set of stanchions (coupled to a handrail), respective guide pins 3225 and cutout guides 3245 function to stabilize the stanchions in the support brackets and prevent collapse or retraction of the stanchions in the absence of the locking pins.

In some embodiments, as shown in FIG. 12, the cutout guide height 3255 on a first side of the device have a height that is greater than the cutout guide height 3254 on a second side of the device, the second side being opposite the first. The increased height of the cutout guide height 3255 on the first side enable the stanchions 140c, 140d on the first side to be folded over the stanchions 140a, 140b from the second side in the retracted or folded configuration, as shown in FIG. 12. In other words, the cutout guide height 3255 on a first side are offset from the cutout guide height 3254 on the second side (e.g., shown in FIGS. 14B-14C).

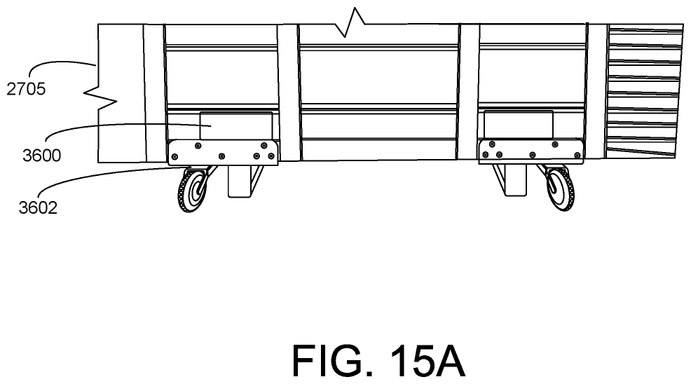

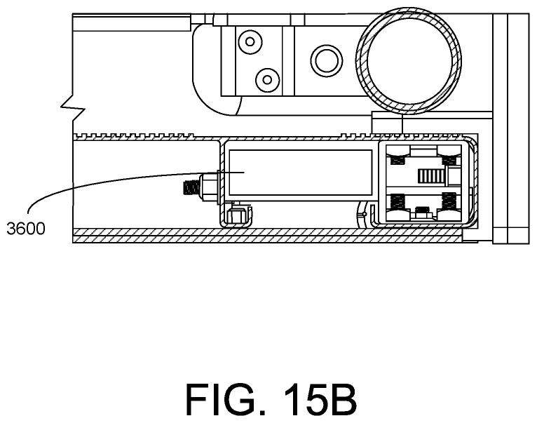

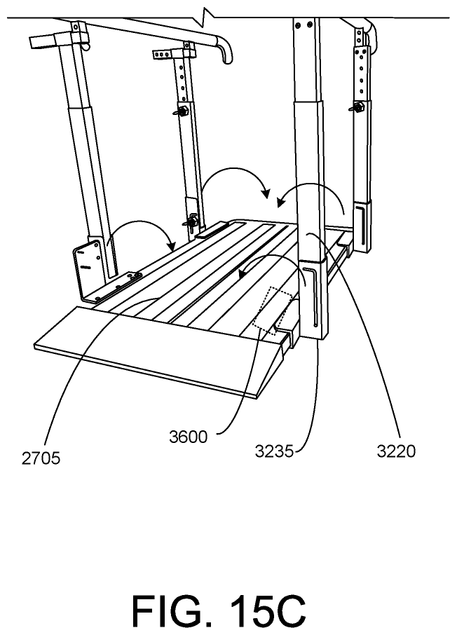

In some embodiments, as shown in FIGS. 15A-15C, one or more additional structural supports 3600 may be inserted, positioned, or otherwise coupled to a bottom portion of the platform 2705 to provide buckling support to the platform surface. For example, one or more structural supports 3600 may be inserted or positioned next or proximate or adjacent to a bottom portion 3602 of a support bracket that is coupled to the platform 2705. FIG. 15B shows a cross-sectional view of the structural support 3600, and FIG. 15C shows a top view of the platform with an outline of where a structural support may be positioned relative to the support bracket 3235 and the bottom portion 2920 of the stanchions, although any location for buckling support is envisioned.

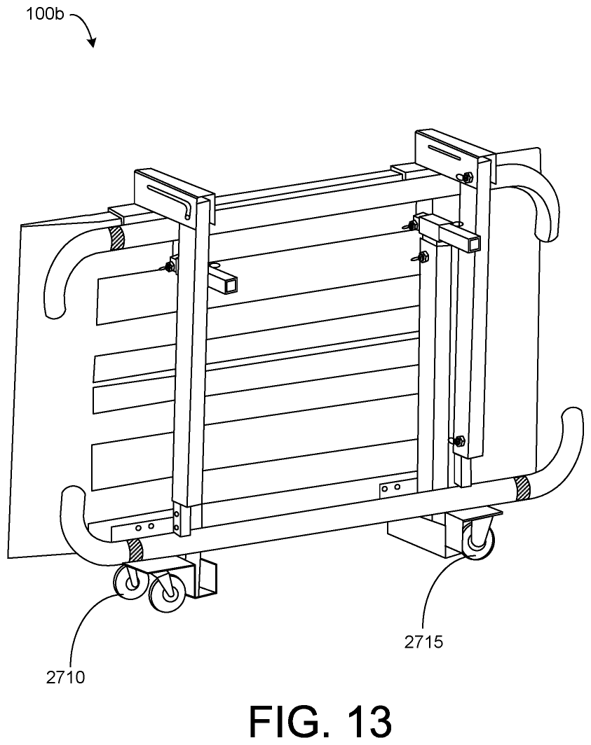

FIG. 13 illustrates a perspective view of the portable device 100b in the transport and/or storing configuration. After the first and second handrail assemblies are rotated and folded on one another, the portable device 100b may be oriented or lifted onto the wheels 2710, 2715 for easy transport to another location.

FIG. 16 illustrates a perspective view of the portable device 100a in an erected or unfolded configuration. The use of this device 100a, the handrail 130, 135 height adjustments, the handrail 130, 135 width adjustments, the handrail 130, 135 length adjustments, and/or handrail 130, 135 folding adjustments may be accomplished by any of the methods and assemblies described elsewhere herein. As shown in this embodiment, one or more wheels, or castors, 2710, 2715, are positioned on a lengthwise side of the platform 2705. The one or more wheels 2710, 2715 are mounted on one or more plates 2720, 2725, which may be fabricated from metal or some other comparable, durable material. The plates 2720, 2725 may be separate pieces that are rotatably coupled to a lengthwise edge 137 of the platform 2705. One or more wheels 2710, 2715 are mounted, such as with bolts or welding, to an outside surface (facing outward from the platform 2705) of each plate 2720, 2725, respectively. It will be appreciated that any number of wheels, or castors, may be used, such as, for example, one wheel, two wheels, three wheels, or four wheels. Further, the plates 2720, 2725 may be larger in width and/or height to accommodate any configuration or number of wheels and ensure stability of the device 100 when in a transport and/or storing configuration. As in a previous embodiment, this embodiment may utilize a first set of support brackets 3235a, 3235b and a second set of support brackets 3235c, 3235d for the folding and erecting of handrails 130 and 135, respectively. The support brackets 3235a, 3235b, 3235c, 3235d and the respective stanchion bottom portions 4220a, 4220b, 4225a, 4225b may function similar to the description of FIGS. 14A-14C with slight dimension differences between the pin guide cutouts of sets 3235a and 3235b (as will be discussed in further detail below). Support bracket 3235a and 3235c are centered or aligned with one another in terms of position along the lengthwise side of the platform 2705. Support bracket 3235b and 3235d are centered or aligned with one another in terms of position along the lengthwise edge 137 of the platform 2705. With the opposing set of support brackets 3235a, 3235c and 3235b, 3235d being centered or aligned with one another, the opposing stanchions may stack on top of one another in a stored configuration, as further described below. The platform 2705 may be constructed of one or more platform members 4210. These platform members may be manufactured by extrusion and have an extrusion cross-section of any suitable geometric shape (e.g., square, rectangular, oval, cee channel, etc.), and may be hollow to decrease overall weight of the device. The one or more extruded platform members 4210 may be constructed of any alloy (e.g., aluminum, steel, etc.), composite, plastic, epoxy enforced fibers (e.g., carbon fiber, etc.), foam, or any other suitable material known in the art. Additionally, the one or more platform members 4210 may have an angled face on one or both ends of its longitudinal length. When these angled faces are aligned (as illustrated), a ramp may be formed and accomplish the ramp capabilities for the platform described in previous embodiments. Alternatively, the platform may include a removable ramp, as described elsewhere herein.

FIG. 17 illustrates a perspective view of the portable device 100b in a folded/storage configuration. The stanchions 145a, 140a of handrail 135 may stack upon the stanchions 145b, 140b of handrail 130, or vice versa. In other words, stanchion 145a, including the respective bottom portion 4225a, may lay directly on top of stanchion 145b and the respective bottom portion 4225b, while stanchion 140a, including the respective bottom portion 4220a, may lie on top of stanchion 140b and the respective bottom portion 4220b, or vice versa. Stacking the stanchions on top of one another may be accomplished via differently dimensioned guide pin cutouts, as will be described below.

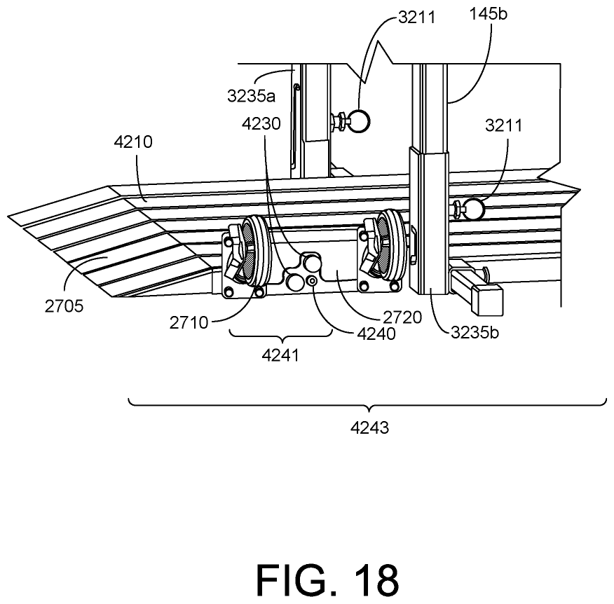

FIG. 18 illustrates the position of the wheel plate 2720 that may correspond with the erect or unfolded configuration of the device 100a. The wheel plate 2720 may be rotatably coupled to one or more platform members 4210 of the platform 2705. This rotation coupling may be accomplished by means of a pivot point 4240 being a pin, bolt, or the like, passing through the wheel plate 2720 and into the one or more platform members 4210, with an optional friction reducing bushing, bearing, or the like. The wheel plate 2720 may have one or more pins 4230 responsible for the locking of the wheel plate 2720 in its respective position. The wheel plate 2720 shown has two pins 4230. One or more holes defined in the device are positioned to receive and hold one or both of the locking pins 4230 when the wheel plate is in a desired position. These pins 4230 may be a loaded spring-based pin, such that the pin holds itself in the engaged position and must be actively held in the disengaged position. In this erect configuration, the wheel plate 2720 is shown as having its longitudinal length 4241 configured to be parallel to the longitudinal length 4243 of the platform 2705. Positioned in this way, the wheel plate 2720 does not break the bottom surface plane of the platform 2705, thus allowing stability enhancing weight transfer to the bottom surface of the platform 2705. Any other wheel plate (e.g., wheel plate 2725) contemplated for any embodiment may have the foregoing capabilities. The position of wheel 2710 is such that it does not break the plane of the surface on which the base or platform rests when the device is in an unfolded configuration to provide further stability to the device in the unfolded configuration.

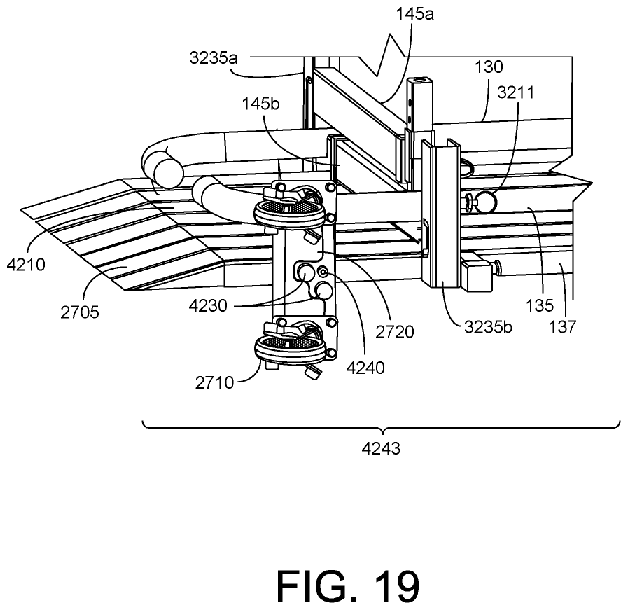

FIG. 19 illustrates the position of the wheel plate 2720 that may correspond with the folded configuration of the device 100b. The wheel plate 2720 may rotate into the depicted position via the pivot point 4240, once the corresponding pin 4230 is disengaged. For example, the wheel plate 2720 may be rotated about 80 degrees to about 100 degrees with respect to a longitudinal length 4243 of the platform 2705. Embodiments using two spring-loaded pins 4230 may use pins 4230 with an angled face, such that rotating the wheel plate 2720 automatically presses the pin 4230 back and allows it to fall into its engagement hole once the wheel plate 2720 is in the desired position. During a folded configuration, the wheel plate 2720 may be positioned with its longitudinal length (shown in FIG. 18) perpendicular to the lengthwise edge 137 of the platform 2705, and its longitudinal length (shown in FIG. 18) parallel to the longitudinal length of the stanchion of the erected device 100a configuration. In the unfolded configuration, wheel plate 2720 improves safety because it is disengaged from the floor or surface and therefore cannot roll while the device 100a is in use. Any other wheel plate (e.g., wheel plate 2725) contemplated for any embodiment may have the foregoing capabilities.

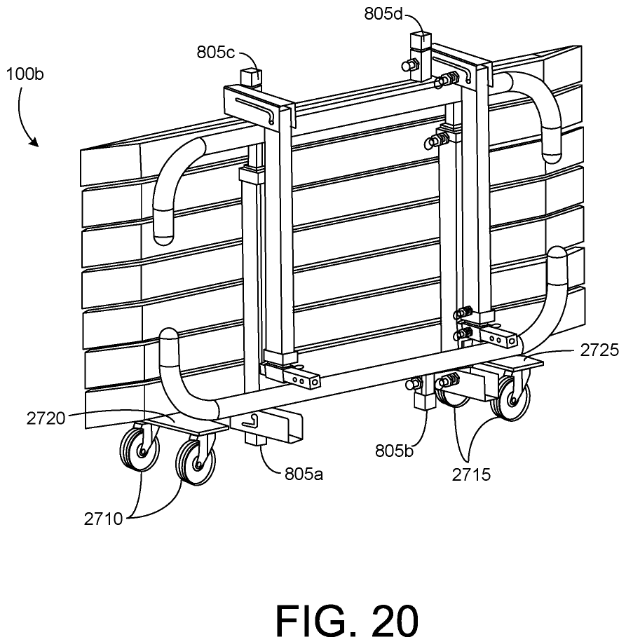

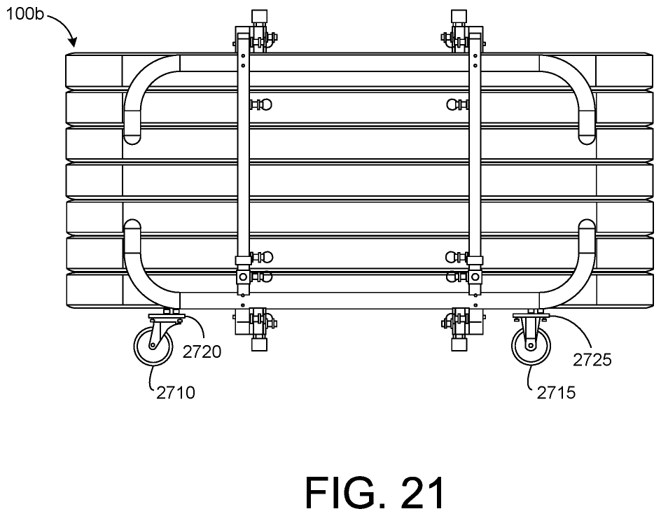

As shown in FIGS. 20-21, once the folded device 100b is erected such that the wheels 2710, 2715 are in contact with the ground, the stable wheelbase created by the wheel plate 2720 can be appreciated. In an embodiment, wheel 2710 is a swivel wheel and wheel 2715 is fixed for easy transportation. In an embodiment, wheels 2710, 2715 are both swivel wheels or both are fixed. In another embodiment, wheel 2715 is a swivel wheel and wheel 2710 is fixed. These wheel features may be combined with any of the embodiments described elsewhere herein.

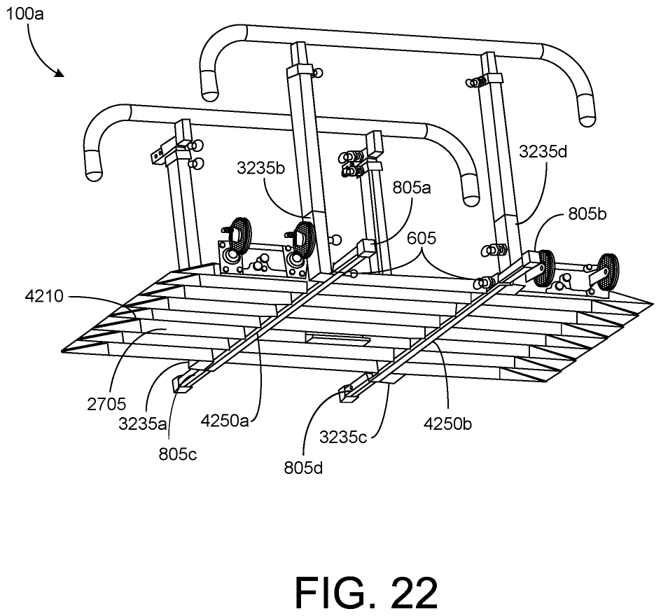

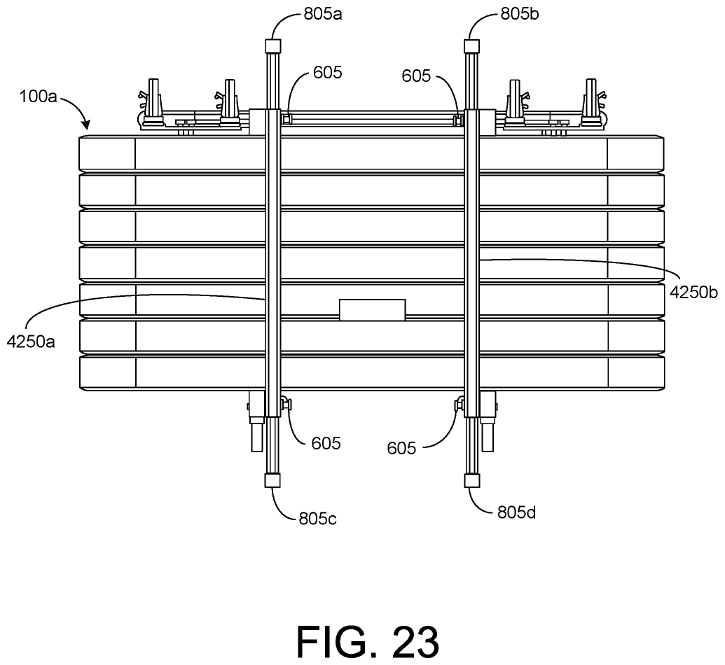

FIG. 22 gives a perspective view of an embodiment of the device 100a, in which the substructure of the platform 2705 is seen. As shown in FIG. 22, device 100a includes a first cross-member 4250a that couples the first support bracket 3235a to second support bracket 3235c, and a second cross-member 4250b that coupled the third support bracket 3235b to fourth support bracket 3235d. The cross-members 4250a, 4250b may increase the rigidity of the device 100a in the erected or unfolded configuration. These cross-members 4250a, 4250b may be made of an alloy, composite, epoxy enforced fiber, or any other suitable material known in the art. The smallest cross-section of the cross-members 4250a, 4250b may be of a geometry with a relatively high moment of inertia for decreased strain during bending. Examples of high moment of inertia geometries may be square, rectangular, box-section, I-beam, or the like. The reduced strain during use increases the rigidity and stability of the device 100a in the erect configuration. The cross-members 4250a, 4250b may serve as a substructure for a platform or base panel, such that the platform or base panel can be fastened to the cross-members 4250a, 4250b. In some embodiments, the cross-members 4250a, 4250b may be hollow such that one or more stability supports 805a, 805b, 805c, and 805d slide or translate within cross-members 4250a, 4250b. For example, the stability support 805a, 805b, 805c, 805d may be translated out of the respective cross-member 4250a, 4250b during the erect or unfolded configuration of the device 100a for added stability, and translated in during the folded configuration of the device 100b. The extended positions of the stability supports 805a, 805b, 805c, and 805d can be seen in FIGS. 16, 18, 22, 23, 25, and 26 of the device 100a. FIGS. 17, 19, 20 and 24 show the stability supports 805a, 805b, 805c, and 805d inserted into the cross-members 4250a, 4250b in the folded configuration. Additionally, the lack of obstruction caused by translating in the stability supports 805a, 805b, 805c, and 805d is shown in FIGS. 20-21. Some stability support 805a, 805b, 805c, 805d lengths may cause unwanted contact between themselves and the ground during wheeled transport of the device 100 if not slid in. Some embodiments include stability pins 605 depicted in FIGS. 22-24. These stability pins 605 may be used to lock the stability supports 805a, 805b, 805c, 805d in their extended configuration and their stowed configuration. Locking the stability supports 805a, 805b, 805c, 805d in these embodiments includes placing the pin 605 through approximately concentric holes passing through and defined by at least a portion of both the stability support 805a, 805b, 805c, 805d and the respective cross-member 4250a, 4250b. The stability pins 605 may be spring-loaded pins, such that they are held in the disengaged position and rest in the engaged position. When the spring-loaded stability pins 605 are used, the stability supports 805a, 805b, 805c, 805d are moved in or out while the pin 605 is held disengaged. Once the stability support reaches the desired position, the pin 605 rests in an appropriate hole defined by the stability support 805a, 805b, 805c, 805d. Although an extended and inserted configuration is shown for the stability supports 805a, 805b, 805c, 805d, it will be appreciated that any number of intermediate positions are also contemplated herein.

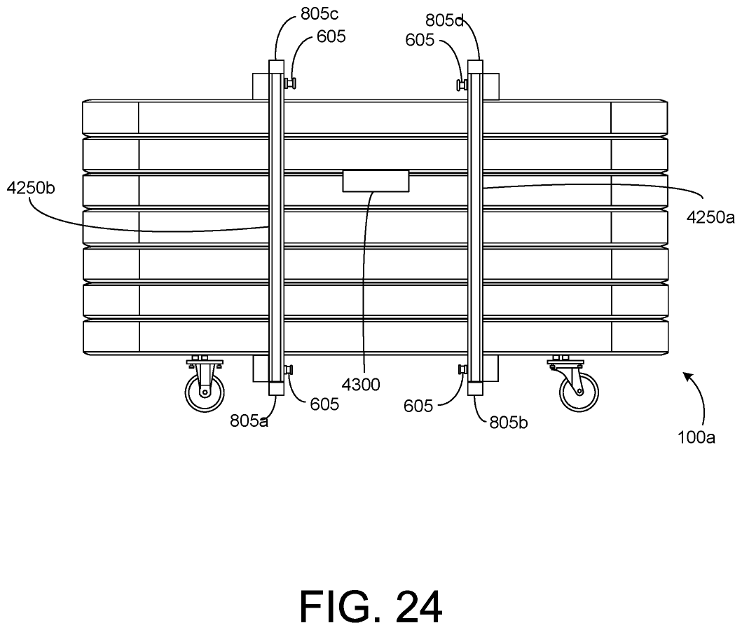

FIG. 24 illustrates an embodiment with a handle 4300 that may be used by a user. The illustrated handle 4300, placed underneath the platform 2705, may be used during the lifting or lowering of a device 100b, or during the transportation of the device 100b.

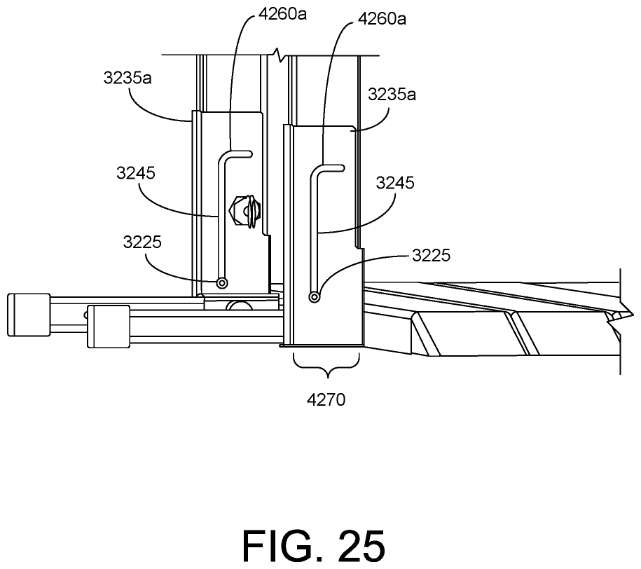

FIG. 25 illustrates the guide pins 3225, guide pin cutouts 3245, guide radius 4260a, and support brackets 3235a, 3235b of an embodiment of the device. The guide pin 3225 is movable within the guide pin cutout 3245, as described for FIG. 14A above. The guide radius 4260a may be about 10 mm to about 40 mm; about 27 mm to about 37 mm; about 29 mm to about 35 mm; about 30 mm to about 33 mm, about 10 mm to about 20 mm, about 13 mm to about 17 mm, about 5 mm to about 20 mm, etc. A guide radius 4260a may adapted based on stanchion width 4270 (the outside width of the stanchion perpendicular to the longitudinal length of the platform 2705).

FIG. 26 illustrates the guide pin cutouts 3245 of both sets of supporting brackets of an embodiment. In this embodiment, the guide pin cutouts 3245 of the supporting brackets 3235a, 3235b are longer than the guide pin cutouts 3245 of the supporting brackets 3235c, 3235d, with respect to the platform 2705. The height ratio (4280 to 4290) of these guide pin cutouts 3245 could be inverse, with the goal being to accomplish stacking stanchions upon one another, as described above.

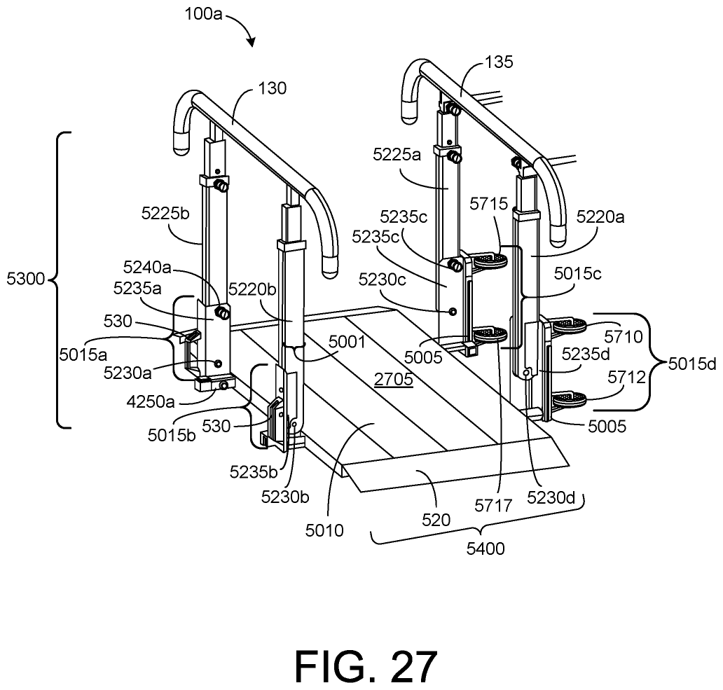

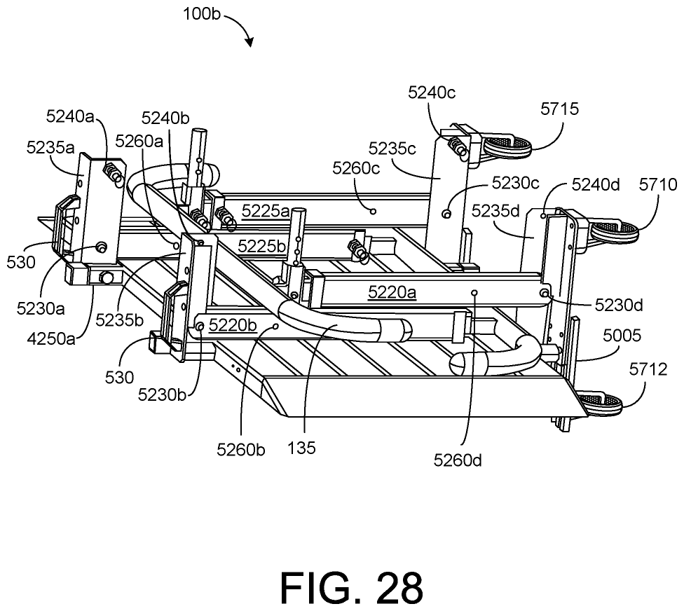

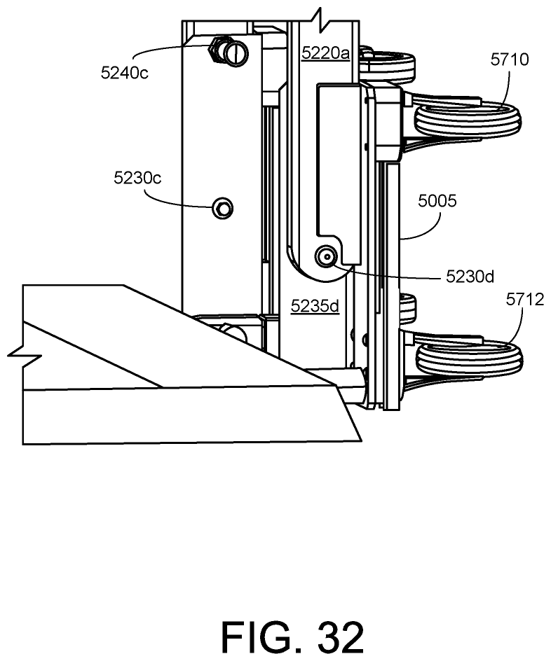

Further embodiments, such as the embodiment illustrated in FIG. 27, may include any of the features discussed above, with alternative folding and locking mechanisms. FIG. 27 depicts a device in an unfolded configuration, such that the stanchions are upright and locked into their respective support bracket. For example, embodiments may utilize one or more stanchion 5225b, 5220b, 5225a, 5220a rotatably coupled to a respective support bracket 5235a, 5235b, 5235c, 5235d. The advantage of the implementation shown in FIGS. 27-32 is that having a hinged connection between the stanchion and the support bracket reduces or eliminates lifting and navigating a pin of the stanchion through the arcuate path of the support bracket, as shown and described elsewhere herein. As shown in FIG. 27, stanchion 5220b may be hingedly coupled to support bracket 5235b, for example using a hinge pin 5230b. In this embodiment, the hinge pin 5230b is positioned near the base of support bracket 5235b. In some variations (e.g., variations including a platform 2705), the hinge pin 5230b position may be approximately one half of the width 5001 of the stanchion 5220b (although any width is envisioned), with respect to a cross-sectional plane perpendicular to the handrails 130, 135. Embodiments that position the hinge pin 5230b in substantial alignment with a top surface 5010 of a platform 2705 have the advantage of the platform 2705 supporting the stanchion 5220b, when the stanchion is in the folded position, as shown in FIG. 28. Each support bracket 5235a, 5235b, 5235c, 5235d has a length 5015a, 5015b, 5015c, 5015d, respectively. Each support bracket hinge pin 5230a, 5230b, 5230c, 5230d is located at a position such that at least a top portion of the respective support bracket is above the hinge position and at least a section of the top portion is in the path of the stanchion swing path. In other words, when unfolding the stanchions, the stanchions will contact a section of the top portion when the respective stanchion is in the upright position.

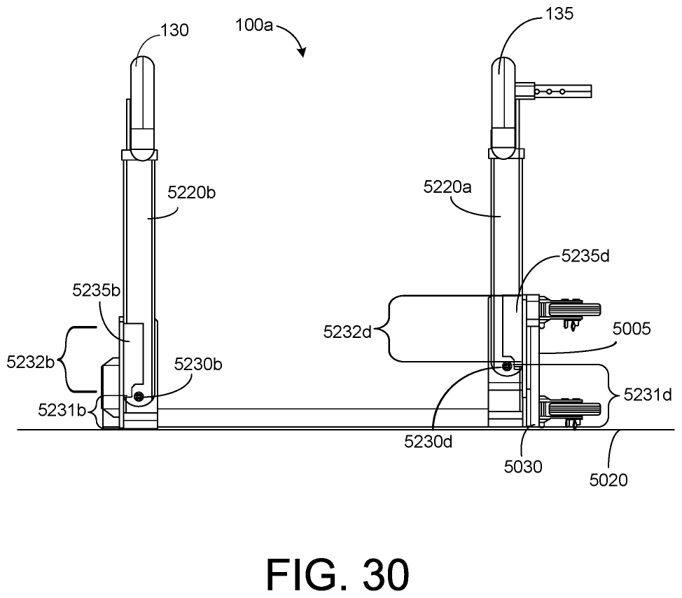

FIG. 30 depicts the top portion 5232b, which may be representative of the top portion of support brackets 5235a and 5235b in the swing path of their respective stanchion. FIG. 30 additionally depicts the top portion 5232d, which may be representative of the top portion of support brackets 5235c and 5235d in the swing path of their respective stanchions. As shown in FIG. 27, each stanchion 5225a, 5225b, 5220a, 5220b, when unfolded, contacts each top portion 5232b, 5232d (e.g., shown in FIG. 30) of each support bracket 5235a, 5235b, 5235c, 5235d at the desired unfolded position. Referring to FIG. 27 and FIG. 28, each stanchion 5225a, 5225b, 5220a, 5220b receives a respective locking pin 5240a, 5240b, 5240c, 5240d. Referring further to FIG. 27 and FIG. 28, each locking pin actuates through a locking pin aperture defined by the support bracket 5235a, 5235b, 5235c, 5235d and into a locking pin aperture 5260a, 5260b, 5260c, 5260d positioned in and defined by each stanchion 5225a, 5225b, 5220a, 5220b. Pinned in this manner, each stanchion 5225a, 5225b, 5220a, 5220b, is braced by each respective pin 5240a, 5240b, 5240c, 5240d and secured from rotating back toward the folded configuration. The device 100a may experience forces on each stanchion 5225a, 5225b, 5220a, 5220b, for example in the direction opposite of folding. For example, a user bracing themselves upon the handrails 130, 135 may create forces in directions attempting to separate or collapse the handrails 130, 135. If these forces are created, the embodiment has the advantage of the pin(s) 5230a, 5230b, 5230c, 5230d and the top portion of the support bracket(s) 5235a, 5235b, 5235c, 5235d bracing against the created forces and stabilizing the stanchion(s) in the support bracket. Further support brackets 5335a and 5235c and support brackets 5235b and 5235d may be coupled together by a first and second cross-member 4250, which increases the rigidity of the physical therapy device 100a in the unfolded configuration.

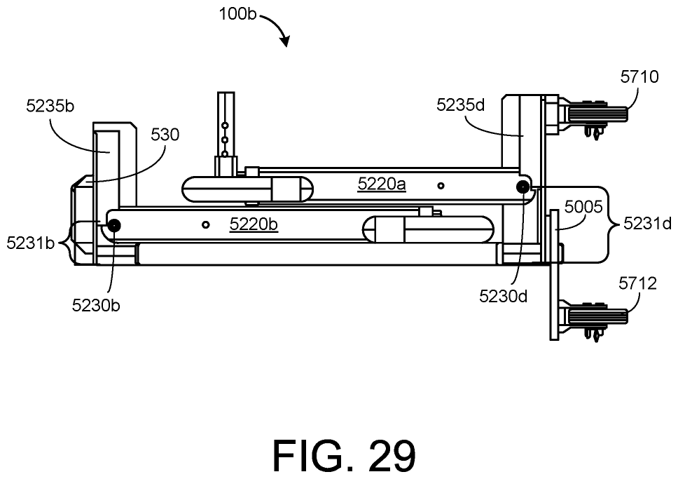

FIG. 28 depicts an embodiment of the present invention in a folded configuration. Folding the depicted embodiment may require disengagement of each stanchion locking pin 5240a, 5240b, 5240c, 5240d. Once these locking pins are disengaged, each set of stanchions 5225b and 5220b, 5225a and 5220a may begin to rotate inward and toward the frame or platform to form the folded configuration shown. In embodiments in which the height of stanchions 5225a, 5220a and stanchions 5225b, 5220b have a height 5300 (shown in FIG. 27) in their lowered position, which when added together (combined height), is less than the approximate width 5400 (shown in FIG. 27) of the platform 2705, the height of each hinge pin 5230a, 5230b, 5230c, 5230d may be approximately equal. In such embodiments, the stanchions 5225a, 5220a, 5225a, 5225b may rest upon the platform 2705. The depicted embodiment stacks stanchions 5225a, 5220a on top of stanchions 5225b, 5220b. The embodiment accomplishes this by incorporating hinge pins 5230c, 5230d at a greater height than hinge pins 5230a, 5230b. For example, hinge pins 5230a, 5230b may be about 30% to about 80%, about 40% to about 60%, about 50% to about 60%, etc. of the height of hinge pins 5230c, 5230d. Referring to FIG. 29, to accomplish this hinge pin configuration, hinge pins 5230c, 5230d height are shown as 5231d, and hinge pins 5230a, 5230b height are shown as 5231b. This hinge position configuration allows stanchions 5225b, 5220b to fold in and rest upon the platform 2705, and stanchions 5225a, 5220a to fold in and rest upon stanchions 5225b, 5220b. The unfolded device 100a is shown in FIG. 30 and the folded device 100b is shown in FIG. 29, further exemplifying the capabilities achieved by the hinge pin height configuration.

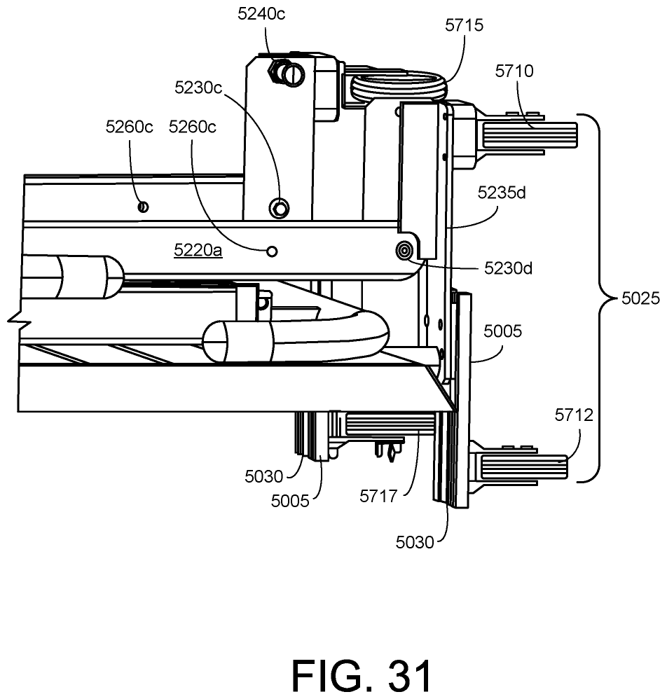

Embodiments illustrated in FIGS. 27-32 further depict another transport-wheel configuration. As shown, wheels 5715, 5710 are coupled to support brackets 5235c, 5235d, respectively. Additionally, wheels 5717, 5712 may be coupled to a respective plate 5005, coupled to support brackets 5235c, 5235d, respectively. The coupling of wheels 5710, 5712, 5715, 5717 may be fixed, rotatable, or any combination thereof. Plates 5005 may slide back and forth on their respective support brackets 5235d and 5235c, with a slide path perpendicular to the surface the device rests upon in the unfolded configuration. The slide mechanism for the plates 5005 may be a guide pin and guide pin cutout, a roller mechanism, a rail system, or any other appropriate mechanism known in the art. Plates 5005 may be spring loaded with a bias direction opposite the handrail 135, in the unfolded configuration. Plates 5005, when unrestricted, may move to the positions shown in FIG. 29. Plates 5005 may use tension spring, tension elements (e.g., elastics), or compression springs for actuation. The described bias components may create, alone or in combination, a force, at the position shown FIG. 29, less than the gravitational force pressing the unfolded device down to lay flush on the surface it rests upon. The described configuration allows the weight of the device 100a to hold the plates 5005 up and in the position depicted in FIGS. 27, 30, and 32. This position includes a lower face 5030 of the plates 5005 held flush with the bottom surface of the device and the surface the device rests upon in the unfolded configuration. The surface the device rests on in the unfolded configuration may also be referred to as the ground plane 5020, shown in FIG. 30. Positioned in this way, the plates 5005 do not break the bottom surface plane of the platform 2705, thus allowing stability enhancing weight transfer to the bottom surface of the platform 2705. When the device 100b is in the folded configuration and rotated such that the wheels 5710, 5712, 5715, 5717 now contact the ground plane 5020, the bias plates 5005 extend away from their respective support brackets 5235d, 5235c. Extension of plates 5005 increases the width 5025 (e.g., in FIG. 31) between wheels 5710 and 5712, as well as the width between wheels 5715 and 5717. Increasing these widths increases the stability of the device when being transported. Transportation may also be improved by the use of handles 530 coupled to support brackets 5235a, 5235b. When the device is folded and positioned with wheel 5710, 5712, 5715, 5717 in contact with the ground plane, handles 530 are proximal to a user's waist making them a preferable height for the user to guide and manipulate the transported device. Each wheel 5710, 5712, 5715, 5717 may be pivotally attached to plate 5005 or fixedly attached to plate 5005.

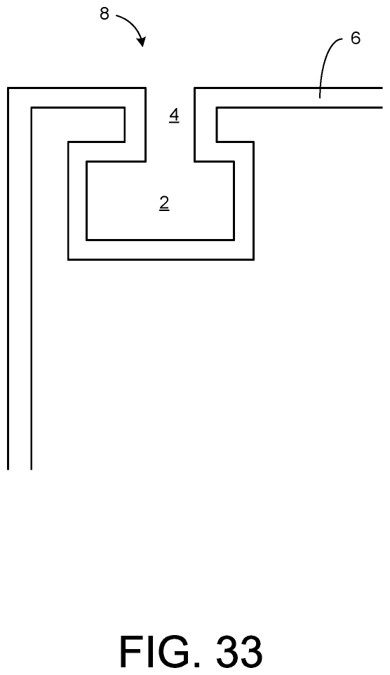

It is further contemplated that a T-track or multiple T-tracks, as illustrated in FIG. 33, may be used in conjunction with any of the embodiments described above. Such T-tracks 8 may be formed by extrusion of the cross-section depicted in FIG. 33. By doing so, a track portion 2 is defined in the extrusion. In addition, a neck portion 4 is also defined by the extrusion. The width of the neck portion 4 is less than the width of the track portion 2. As such, an auxiliary device (e.g., step, exercise band, etc.) with a similarly shaped base or base portion (e.g., having a cross-section similar to the cross-section defined by the track portion 2 and the neck portion 4) may slip into the T-track 8 and have the capability of translation along the extrusion, perpendicular to the cross-section illustrated in FIG. 33. Additionally, the device can be restrained in all other degrees of freedom. T-tracks 8 may be formed in the platform 2705 of the device, or as part of the handrails 130, 135. As such, auxiliary devices may be easily and rigidly positioned all along the T-tracks. For example, a step device may be slid to a position on the device platform 2705. The step device would be rigid in all aspects of a user using it for rehabilitation purposes.

It is also contemplated that two or more devices may be configured to couple with one another to form a larger version (e.g., longer version) of the present device. Described embodiments may utilize removable ramps 120, 125. Removing one or more ramps 120, 125 may reveal a fastening feature to enable fastening of two or more devices 100 together. The fastening features may provide a male connector and female connector, a pin and aperture, a strap and D-ring, or any other fastening feature known in the art. To further facilitate coupling multiple devices together, curved handles 150a-b, 155a-b may also be removable. Once again, removal of curved handles 150a-b, 155a-b may expose fastening features for the connection of the handrails 130, 135 of the coupled devices 100. In this manner, continuous handrails may be formed for the two or more coupled devices 100a.

The present device is depicted and described with two stanchions per handrail. It is contemplated that larger devices, such as 3 m to 5 m in length, may be constructed and practiced. These larger devices 100 may require three or more stanchions per handrail, but may largely perform as embodiments described above.

With the advantages and novelty of the embodiments described, it can be appreciated that this field of innovation requires rigid and durable construction with light-weight and easily transportable devices.

As used in the description and claims, the singular form “a”, “an” and “the” include both singular and plural references unless the context clearly dictates otherwise. For example, the term “number” may include, and is contemplated to include, a plurality of holes. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or pressure), indicates approximations which may vary by (+) or (−) 5%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

### Example Embodiments

Example 1. A physical therapy device configured for easy transporting, the physical therapy device comprising: a first support bracket having a top portion and a bottom portion; a first cross-member coupled to the bottom portion of the first support bracket; and a first stanchion rotatably coupled to the first support bracket at a first hinge point, wherein the device is configured to be transitioned between a folded configuration and an unfolded configuration, wherein, in the unfolded configuration, the first stanchion is configured to rotate about the first hinge point to contact the top portion of the first support bracket above the first hinge point, such that the first stanchion is approximately perpendicular to the first cross-member. wherein, in the folded configuration, the first stanchion is configured to rotate about the first hinge point to be approximately parallel to the first cross-member.

Example 2. The physical therapy device of any of the preceding embodiments, but particularly Example 1, wherein the first stanchion has a rotation arc of about 80 degrees to about 90 degrees.

Example 3. The physical therapy device of any of the preceding embodiments, but particularly Example 1, further comprising one or more stability supports.

Example 4. The physical therapy device of any of the preceding embodiments, but particularly Example 3, wherein the one or more stability supports are configured to be at least partially contained within the first cross-member.

Example 5. The physical therapy device of any of the preceding embodiments, but particularly Example 4, wherein the one or more stability supports are extendable from the first cross-member.

Example 6. The physical therapy device of any of the preceding embodiments, but particularly Example 1, further comprising a platform coupled to the first cross-member and the first support bracket.

Example 7. The physical therapy device of any of the preceding embodiments, but particularly Example 1, further comprising one or more first wheels coupled to the first support bracket.

Example 8. The physical therapy device of any of the preceding embodiments, but particularly Example 7, further comprising a spring-loaded plate coupled to the first support bracket and comprising one or more second wheels, wherein the spring-loaded plate has an actuation path parallel to the first stanchion in the unfolded configuration, and wherein the spring-loaded plate is bias to a direction opposite the first stanchion.

Example 9. The physical therapy device of any of the preceding embodiments, but particularly Example 8, wherein, in the unfolded configuration, the spring-loaded plate has a first end that is approximately flush with a bottom surface of the device, with respect to a surface that the device rests on in the unfolded configuration.

Example 10. The physical therapy device of any of the preceding embodiments, but particularly Example 8, wherein, in the folded configuration, the spring-loaded plate is configured to extend beyond a bottom surface of the first cross-member, thereby increasing a distance between the one or more first wheels coupled to the first support bracket and the one or more second wheels coupled to the spring-loaded plate.

Example 11. The physical therapy device of any of the preceding embodiments, but particularly Example 1, further comprising a second stanchion rotatably coupled to a second support bracket at a second hinge point, wherein the second support bracket is connected to the first cross-member opposite the first support bracket.

Example 12. The physical therapy device of any of the preceding embodiments, but particularly Example 11, further comprising: a third stanchion rotatably coupled to a third support bracket at a third hinge point; a fourth stanchion rotatably coupled to a fourth support bracket at a fourth hinge point; and a second cross-member, wherein the second cross-member couples the third support bracket to the fourth support bracket,

Example 13. The physical therapy device of any of the preceding embodiments, but particularly Example 12, wherein the first cross-member is parallel to the second cross-member.

Example 14. The physical therapy device of any of the preceding embodiments, but particularly Example 12, wherein the first and third stanchions are coupled to a first handrail, and the second and fourth stanchions are coupled to a second handrail.

Example 15. The physical therapy device of any of the preceding embodiments, but particularly Example 12, wherein the first and third hinge points are at a first height relative to the first and second cross-members and the second and fourth hinge points are at a second height relative to the first and second cross-members.

Example 16. The physical therapy device of any of the preceding embodiments, but particularly Example 15, wherein the second height is greater than the first height such that the second and fourth stanchions are configured to rest on the first and third stanchions when the device is in the folded configuration.

Example 17. A physical therapy device configured for easy transporting, the physical therapy device comprising: a platform comprising a first lengthwise side and a second lengthwise side, opposite the first lengthwise side; a first set of support brackets positioned on the first lengthwise side of the platform; a second set of support brackets positioned on the second lengthwise side of the platform; a first cross-member perpendicular to the first and second lengthwise sides of the platform; a second cross-member perpendicular to the first and second lengthwise sides of the platform; wherein the first cross-member couples a first support bracket from the first set of support brackets to a second support bracket from the second set of support brackets, wherein the second cross-member couples a third support bracket from the first set of support brackets to a fourth support bracket from the second set of support brackets, a first stanchion rotatably coupled to the first support bracket at a first hinge point; a third stanchion rotatably coupled to the third support bracket at a third hinge position; a second stanchion coupled to the second support bracket; a fourth stanchion coupled to the fourth support bracket; wherein at least the first support bracket and the third support bracket each define a locking pin aperture configured to receive a locking pin.

Example 18. The physical therapy device of any of the preceding embodiments, but particularly Example 17, wherein the second stanchion is rotatably coupled to the second support bracket at a second hinge point, and the fourth stanchion is rotatably coupled to the fourth support bracket at a fourth hinge point.

Example 19. The physical therapy device of any of the preceding embodiments, but particularly Example 18, wherein the device is configured to transition from a folded configuration to an unfolded configuration.

Example 20. The physical therapy device of any of the preceding embodiments, but particularly Example 19, wherein, in the folded configuration, the second and fourth stanchions are configured to rest on the first and third stanchions, which are configured to rest on the platform

Example 21. The physical therapy device of any of the preceding embodiments, but particularly Example 18, wherein the first and third hinge points are at a first height relative to the first and second cross-members and the second and fourth hinge points are at a second height relative to the first and second cross-members.

Example 22. The physical therapy device of any of the preceding embodiments, but particularly Example 21, wherein the second height is greater than the first height such that the second and fourth stanchions are configured to rest on the first and third stanchions when the device is in the folded configuration.

Example 23. The physical therapy device of any of the preceding embodiments, but particularly Example 19, wherein, with respect to a ground plane when the device is in the unfolded configuration, a first portion of each of the first support bracket and the third support bracket are above the first hinge position and the third hinge position and in a swing path of their respective stanchion.

Example 24. The physical therapy device of any of the preceding embodiments, but particularly Example 19, wherein, with respect to a ground plane when the device is in the unfolded configuration, a first portion of each of the second support bracket and the fourth support bracket are above the second hinge position and the fourth hinge position, and in a swing path of their respective stanchion.

Example 25. The physical therapy device of any of the preceding embodiments, but particularly Example 17, wherein the first stanchion and the third stanchion have a rotation arc of about 80 degrees to about 100 degrees.

Example 26. The physical therapy device of any of the preceding embodiments, but particularly Example 17, further comprising two or more stability supports.

Example 27. The physical therapy device of any of the preceding embodiments, but particularly Example 26, wherein the two or more stability supports are configured to be at least partially contained within the first cross-member and second cross-member.

Example 28. The physical therapy device of any of the preceding embodiments, but particularly Example 27, wherein the one or more stability supports are extendable from the first cross-member when the physical therapy device is in an unfolded configuration.

Example 29. The physical therapy device of any of the preceding embodiments, but particularly Example 19, wherein, with respect to a surface on which the device rests in an unfolded configuration, the first hinge position and third hinge position are higher than the second hinge position and fourth hinge position.

Example 30. The physical therapy device of any of the preceding embodiments, but particularly Example 29, wherein, in the folded configuration, the first and third stanchions are configured to rest on the second and fourth stanchions.

Example 31. The physical therapy device of any of the preceding embodiments, but particularly Example 17, wherein one or more first wheels are coupled to the first support bracket and third support bracket.

Example 32. The physical therapy device of any of the preceding embodiments, but particularly Example 31, further comprising a spring-loaded plate coupled to the first support bracket and comprising one or more second wheels, wherein the spring-loaded plate has an actuation path parallel to the first stanchion in the unfolded configuration, and wherein the spring-loaded plate is bias to a direction opposite the first stanchion.

Example 33. The physical therapy device of any of the preceding embodiments, but particularly Example 32, wherein, in the unfolded configuration, the spring-loaded plate has a first end that is approximately flush with a bottom surface of the device, with respect to the surface that the device rests on in the unfolded configuration.

Example 34. The physical therapy device of any of the preceding embodiments, but particularly Example 32, wherein, in the folded configuration, the spring-loaded plate is configured to extend beyond a bottom surface of the first cross-member, thereby increasing a distance between the one or more first wheels coupled to the first support bracket and the one or more second wheels coupled to the spring-loaded plate.

Example 35. A physical therapy device configured for easy transporting, the physical therapy device comprising: a platform comprising a first lengthwise side and a second lengthwise side, opposite the first lengthwise side; one or more support brackets coupled to the platform; a first handrail assembly coupled to the first lengthwise side of the platform, wherein the first handrail assembly comprises a first handrail coupled to one or more stanchions, a first stanchion is coupled to a portion of the first lengthwise side; wherein the one or more stanchions comprise an upper portion that is coupled to the first handrail and a bottom portion that is coupled to the one or more respective support brackets; wherein the one or more support brackets define a cutout pin guide; and wherein the bottom portion comprises a pin configured to track through the respective cutout pin guide, and, when retracting the first handrail assembly, the one or more stanchions coupled to the first handrail assembly are configured to be raised so that the respective pins track through the respective cutout pin guides to rotate inwardly on a first hinge mechanism.

Example 36. The physical therapy device of any of the preceding embodiments, but particularly Example 35, wherein the cutout pin guide comprises an arcuate shape.

Example 37. The physical therapy device of any of the preceding embodiments, but particularly Example 36, wherein the arcuate shape has an angle of about 70 degrees to about 130 degrees.

Example 38. The physical therapy device of any of the preceding embodiments, but particularly Example 36, wherein the cutout pin guide comprises a radius of about 25 mm to about 40 mm.

Example 39. The physical therapy device of any of the preceding embodiments, but particularly Example 36, comprising a support bracket inner diameter that is about 220% to about 320% longer than a radius of the cutout pin guide.

Example 40. The physical therapy device of any of the preceding embodiments, but particularly Example 35, further comprising one or more stability supports.

Example 41. The physical therapy device of any of the preceding embodiments, but particularly Example 40, wherein the one or more stability supports hinge from a stowed position parallel to a longitudinal length of the platform, to a use position perpendicular to the longitudinal length of the platform.

Example 42. The physical therapy device of any of the preceding embodiments, but particularly Example 40, wherein the one or more stability supports are configured to be perpendicular relative to a longitudinal length of the platform and perpendicular to the first stanchion in an in-use device configuration.

Example 43. The physical therapy device of any of the preceding embodiments, but particularly Example 42, wherein the one or more stability supports slide from a stowed position to a use position.

Example 44. The physical therapy device of any of the preceding embodiments, but particularly Example 43, wherein the stowed position is defined as having at least a portion of the stability support within the platform.

Example 45. The physical therapy device of any of the preceding embodiments, but particularly Example 43, wherein the use position is defined as having at least a portion of the stability support extending from the platform.

Example 46. A physical therapy device configured for easy transporting, the physical therapy device comprising: a platform comprising a first lengthwise side and a second lengthwise side, opposite the first lengthwise side; a plurality of support brackets coupled to the platform; and a first handrail assembly coupled to the first lengthwise side of the platform, wherein the first handrail assembly comprises a first handrail coupled to a first stanchion and a second stanchion, the first stanchion is coupled to a first portion of the first lengthwise side and the second stanchion is coupled to a second portion of the first lengthwise side; a second handrail assembly coupled to the second lengthwise side of the platform, wherein the second handrail assembly comprises a second handrail coupled to a third stanchion and a fourth stanchion, the third stanchion is coupled to a third portion of the second lengthwise side and the fourth stanchion is coupled to a fourth portion of the second lengthwise side, wherein each stanchion comprises an upper portion that is coupled to a respective handrail and a bottom portion that is coupled to a support bracket of the plurality of support brackets, wherein the respective support bracket for the first stanchion defines a locking pin aperture and a cutout pin guide, wherein the bottom portion of the first stanchion comprises a pin configured to track through the respective cutout pin guide, and when retracting the first handrail assembly, the first stanchion coupled to the first handrail assembly is configured to be raised so that the respective pin tracks through the respective cutout pin guide to rotate inwardly on a first hinge mechanism.

Example 47. The physical therapy device of any of the preceding embodiments, but particularly Example 46, wherein the respective support bracket for the third stanchion defines a locking pin aperture and a cutout pin guide.

Example 48. The physical therapy device of any of the preceding embodiments, but particularly Example 47, wherein, when retracting the second handrail assembly, the third stanchion is configured to be raised so that the respective pin track through the respective cutout pin guide to rotate inwardly on a second hinge mechanism, thereby resting the second handrail assembly on the rotated first handrail assembly.

Example 49. The physical therapy device of any of the preceding embodiments, but particularly Example 46, wherein the cutout pin guide comprises an arcuate shape.

Example 50. The physical therapy device of any of the preceding embodiments, but particularly Example 49, wherein the cutout pin guide comprises a radius of about 25 mm to about 40 mm.

Example 51. The physical therapy device of any of the preceding embodiments, but particularly Example 49, comprising a support bracket inner diameter that is about 220% to about 320% longer than a radius of the cutout pin guide.

Example 52. The physical therapy device of any of the preceding embodiments, but particularly Example 49, wherein the arcuate shape has an angle of about 70 degrees to about 130 degrees.

Example 53. The physical therapy device of any of the preceding embodiments, but particularly Example 46, further comprising a locking pin configured to be received through the locking aperture and into the first stanchion when the stanchion is in an upright position.

Example 54. The physical therapy device of any of the preceding embodiments, but particularly Example 48, wherein the respective cutout pin guide of the first stanchion support bracket has a slot length that is greater than the cutout pin guide in the third stanchion support bracket.

Example 55. The physical therapy device of any of the preceding embodiments, but particularly Example 46, further comprising one or more stability supports.

Example 56. The physical therapy device of any of the preceding embodiments, but particularly Example 55, wherein the one or more stability supports hinge from a stowed position parallel to a longitudinal length of the platform, to a use position perpendicular to the longitudinal length of the platform.

Example 57. The physical therapy device of any of the preceding embodiments, but particularly Example 55, wherein the one or more stability supports are configured to be perpendicular relative to a longitudinal length of the platform and perpendicular to the first stanchion in an in-use device configuration.

Example 58. The physical therapy device of any of the preceding embodiments, but particularly Example 57, wherein the one or more stability supports slide from a stowed position to a use position.

Example 59. The physical therapy device of any of the preceding embodiments, but particularly Example 58, wherein the stowed position is defined as having at least a portion of the stability support within the platform.

Example 60. The physical therapy device of any of the preceding embodiments, but particularly Example 58, wherein the use position is defined as having at least a portion of the stability support extending from the platform.

Example 61. The physical therapy device of any of the preceding embodiments, but particularly Example 46, further comprising one or more plates further comprising one or more wheels.

Example 62. The physical therapy device of any of the preceding embodiments, but particularly Example 61, wherein the one or more plates are coupled to the physical therapy device.

Example 63. The physical therapy device of any of the preceding embodiments, but particularly Example 61, wherein the one or more plates are rectangular and rotatably coupled to the physical therapy device.

Example 64. The physical therapy device of any of the preceding embodiments, but particularly Example 63, wherein the one or more plates have a lengthwise edge perpendicular to the lengthwise edge of the platform when the device is in a folded configuration.

Example 65. The physical therapy device of any of the preceding embodiments, but particularly Example 63, wherein the one or more plates have a lengthwise edge parallel to the lengthwise edge of the platform when the device is in an unfolded configuration.

Example 66. A physical therapy device configured for easy transporting, the physical therapy device comprising: a platform comprising a first lengthwise side and a second lengthwise side, opposite the first lengthwise side; a first set of two or more support brackets positioned on a first lengthwise side of the platform; a second set of two or more support brackets positioned on a second lengthwise side of the platform; a first cross-member perpendicular to a lengthwise side of the platform; a second cross-member perpendicular to a lengthwise side of the platform; wherein a first support bracket from the first set of support brackets is coupled to a first support bracket from the second set of support brackets by the first cross-member; wherein a second support bracket from the first set of support brackets is coupled to a second support bracket from the second set of support brackets by the second cross-member; a first handrail assembly coupled to the first lengthwise side of the platform by the first set of support brackets, wherein the first handrail assembly comprises a first handrail coupled to two stanchions, a first stanchion is coupled to a first portion of the first lengthwise side and a second stanchion is coupled to a second portion of the first lengthwise side; a second handrail assembly coupled to the second lengthwise side of the platform by the second set of support brackets, the second lengthwise side being opposite the first lengthwise side, wherein the second handrail assembly comprises a second handrail coupled to two stanchions, a third stanchion is coupled to a third portion of the second lengthwise side and a fourth stanchion is coupled to a fourth portion of the second lengthwise side, wherein each stanchion comprises an upper portion that is coupled to a respective handrail and a bottom portion that is coupled to a support bracket of the respective set of support brackets; wherein each support bracket defines a locking pin aperture and a cutout pin guide; and wherein each of the bottom portion of each stanchion comprises a pin configured to track through the respective cutout pin guide, and, when retracting the first and second handrail assemblies, the first and second stanchions coupled to the first handrail assembly are configured to be raised so that the respective pins track through the respective cutout pin guides to rotate inwardly on a first hinge mechanism, and the third and fourth stanchions coupled to the second handrail assembly are configured to be raised so that the respective pins track through the respective cutout pin guides to rotate inwardly on a second hinge mechanism, thereby resting on the rotated first handrail assembly.

Example 67. The physical therapy device of any of the preceding embodiments, but particularly Example 66, wherein the cutout pin guide comprises an arcuate shape.

Example 68. The physical therapy device of any of the preceding embodiments, but particularly Example 67, wherein the cutout pin guide comprises a radius of about 10 mm to about 40 mm.

Example 69. The physical therapy device of any of the preceding embodiments, but particularly Example 67, comprising a support bracket inner diameter that is about 220% to about 320% longer than a radius of the cutout pin guide.

Example 70. The physical therapy device of any of the preceding embodiments, but particularly Example 67, wherein the arcuate shape has an angle of about 70 degrees to about 130 degrees.

Example 71. The physical therapy device of any of the preceding embodiments, but particularly Example 66, further comprising a locking pin configured to be received in the locking aperture.

Example 72. The physical therapy device of any of the preceding embodiments, but particularly Example 66, wherein the respective cutout pin guides in the respective support brackets on the first lengthwise side have a slot length that is greater than the respective cutout pin guides in the respective support brackets on the second lengthwise side.

Example 73. The physical therapy device of any of the preceding embodiments, but particularly Example 66, further comprising two or more stability supports perpendicular to a lengthwise side of the platform.

Example 74. The physical therapy device of any of the preceding embodiments, but particularly Example 73, wherein the one or more stability supports are configured to be at least partially contained within one or both the first cross-member and second cross-member.

Example 75. The physical therapy device of any of the preceding embodiments, but particularly Example 74, wherein the one or more stability supports are extended from one or both the first cross-member and the second cross-member when the physical therapy device is in an unfolded configuration.

Example 76. The physical therapy device of any of the preceding embodiments, but particularly Example 74, wherein the two or more stability supports are retracted into one or both the first cross-member and the second cross-member when the physical therapy device is in a folded configuration.

Example 77. A physical therapy device configured for easy transporting, the physical therapy device comprising: a first support bracket; a first cross-member; and a first handrail assembly coupled to the first support bracket by a first stanchion, wherein the first support bracket defines a cutout pin guide, wherein the cross-member is coupled to the first support bracket, wherein the first cross-member is perpendicular to the first stanchion, when the device is in an unfolded configuration, and the first stanchion is perpendicular to the first handrail, when the device is in either a folded configuration or unfolded configuration, wherein the bottom portion of the first stanchion comprises a pin configured to track through the cutout pin guide, and, when retracting the first handrail assembly, the first stanchion coupled to the first handrail assembly is configured to be raised so that the respective pin track through the respective cutout pin guide to rotate inwardly on a first hinge mechanism.

Example 78. The physical therapy device of any of the preceding embodiments, but particularly Example 77, wherein the cutout pin guide comprises an arcuate shape.

Example 79. The physical therapy device of any of the preceding embodiments, but particularly Example 78, wherein the cutout pin guide comprises a radius of about 10 mm to about 40 mm.

Example 80. The physical therapy device of any of the preceding embodiments, but particularly Example 78, comprising a support bracket inner diameter that is about 220% to about 320% longer than a radius of the cutout pin guide.

Example 81. The physical therapy device of any of the preceding embodiments, but particularly Example 78, wherein the arcuate shape has an angle of about 70 degrees to about 130 degrees.

Example 82. The physical therapy device of any of the preceding embodiments, but particularly Example 77, further comprising one or more stability supports.

Example 83. The physical therapy device of any of the preceding embodiments, but particularly Example 82, wherein the one or more stability supports are configured to be at least partially contained within the first cross-member.

Example 84. The physical therapy device of any of the preceding embodiments, but particularly Example 83, wherein the one or more stability supports are extended from the first cross-member when the physical therapy device is in an unfolded configuration.

Example 85. The physical therapy device of any of the preceding embodiments, but particularly Example 83, wherein the one or more stability supports are retracted into the one or more cross-members when the physical therapy device is in a folded configuration.

1. A physical therapy device configured for easy transporting, the physical therapy device comprising:
a first support bracket having a top portion and a bottom portion;
a first cross-member coupled to the bottom portion of the first support bracket;
one or more stability supports configured to be at least partially contained within the first cross-member; and
a first stanchion rotatably coupled to the first support bracket at a first hinge point,
wherein the physical therapy device is configured to be transitioned between a folded configuration and an unfolded configuration,
wherein, in the unfolded configuration, the first stanchion is configured to rotate about the first hinge point to contact the top portion of the first support bracket above the first hinge point, such that the first stanchion is approximately perpendicular to the first cross-member, and
wherein, in the folded configuration, the first stanchion is configured to rotate about the first hinge point to be approximately parallel to the first cross-member.

2. (canceled)

3. (canceled)

4. (canceled)

5. The physical therapy device of claim 1, wherein the one or more stability supports are extendable from the first cross-member.

6. (canceled)

7. (canceled)

8. The physical therapy device of claim 1, further comprising one or more first wheels coupled to the first support bracket; and a spring-loaded plate coupled to the first support bracket and comprising one or more second wheels, wherein the spring-loaded plate has an actuation path perpendicular to a surface the physical therapy device rests on in the unfolded configuration, and wherein the spring-loaded plate is bias to a direction opposite the one or more first wheels.

9. The physical therapy device of claim 8, wherein, in the unfolded configuration, the spring-loaded plate has a first end that is approximately flush with a bottom surface of the physical therapy device, with respect to a surface that the physical therapy device rests on in the unfolded configuration.

10. The physical therapy device of claim 8, wherein, in the folded configuration, the spring-loaded plate is configured to extend beyond a bottom surface of the first cross-member, thereby increasing a distance between the one or more first wheels coupled to the first support bracket and the one or more second wheels coupled to the spring-loaded plate.

11. (canceled)

12. (canceled)

13. (canceled)

14. (canceled)

15. (canceled)

16. (canceled)

17. A physical therapy device configured for easy transporting, the physical therapy device comprising:
a platform comprising a first lengthwise side and a second lengthwise side, opposite the first lengthwise side;
a first set of support brackets positioned on the first lengthwise side of the platform;
a second set of support brackets positioned on the second lengthwise side of the platform;
a first cross-member perpendicular to the first and second lengthwise sides of the platform;
a second cross-member perpendicular to the first and second lengthwise sides of the platform;
wherein the first cross-member couples a first support bracket from the first set of support brackets to a second support bracket from the second set of support brackets,
wherein the second cross-member couples a third support bracket from the first set of support brackets to a fourth support bracket from the second set of support brackets,
a first stanchion rotatably coupled to the first support bracket at a first hinge point;
a third stanchion rotatably coupled to the third support bracket at a third hinge position;
a second stanchion coupled to the second support bracket; and
a fourth stanchion coupled to the fourth support bracket;
wherein at least the first support bracket and the third support bracket each define a locking pin aperture configured to receive a locking pin.

18. The physical therapy device of claim 17, wherein the second stanchion is rotatably coupled to the second support bracket at a second hinge point, and the fourth stanchion is rotatably coupled to the fourth support bracket at a fourth hinge point.

19. The physical therapy device of claim 18, wherein the physical therapy device is configured to transition from a folded configuration to an unfolded configuration; and
wherein, in the folded configuration, the second and fourth stanchions are configured to rest on the first and third stanchions, which are configured to rest on the platform.

20. (canceled)

21. The physical therapy device of claim 18, wherein the first and third hinge points are at a first height relative to the first and second cross-members and the second and fourth hinge points are at a second height relative to the first and second cross-members.

22. The physical therapy device of claim 21, wherein the second height is greater than the first height such that the second and fourth stanchions are configured to rest on the first and third stanchions when the physical therapy device is in a folded configuration.

23. The physical therapy device of claim 19, wherein, with respect to a ground plane when the physical therapy device is in the unfolded configuration, a first portion of each of the first support bracket and the third support bracket are above the first hinge position and the third hinge position and in a swing path of their respective stanchion.

24. The physical therapy device of claim 19, wherein, with respect to a ground plane when the device is in the unfolded configuration, a first portion of each of the second support bracket and the fourth support bracket are above the second hinge position and the fourth hinge position, and in a swing path of their respective stanchion.

25. (canceled)

26. The physical therapy device of claim 17, further comprising two or more stability supports.

27. The physical therapy device of claim 26, wherein the two or more stability supports are configured to be at least partially contained within the first cross-member and the second cross-member.

28. The physical therapy device of claim 27, wherein the one or more stability supports are extendable from the first cross-member when the physical therapy device is in an unfolded configuration.

29. The physical therapy device of claim 19, wherein, with respect to a surface on which the device rests in the unfolded configuration, the first hinge position and the third hinge position are higher than the second hinge position and the fourth hinge position.

30. The physical therapy device of claim 29, wherein, in the folded configuration, the first and third stanchions are configured to rest on the second and fourth stanchions.

31. (canceled)

32. The physical therapy device of claim 17, further comprising one or more first wheels coupled to the first support bracket and the third support bracket; and a spring-loaded plate coupled to the first support bracket and comprising one or more second wheels, wherein the spring-loaded plate has an actuation path perpendicular to a surface the physical therapy device rests on in an unfolded configuration, and wherein the spring-loaded plate is bias to a direction opposite the one or more first wheels.

33. The physical therapy device of claim 32, wherein, in the unfolded configuration, the spring-loaded plate has a first end that is approximately flush with a bottom surface of the physical therapy device, with respect to a surface that the physical therapy device rests on in the unfolded configuration.

34. The physical therapy device of claim 32, wherein, in a folded configuration, the spring-loaded plate is configured to extend beyond a bottom surface of the first cross-member, thereby increasing a distance between the one or more first wheels coupled to the first support bracket and the one or more second wheels coupled to the spring-loaded plate.
